(19) United States
(12) Patent Application Publication
(10) Pub. No.: US 2024/0223745 A1
(43) Pub. Date: Jul. 4, 2024

(54) EYEBOX TARGETING USING AN IMAGE-REPLICATING COMBINER

(71) Applicant: VividQ Limited, London (GB)

(72) Inventors: Alfred James NEWMAN, London (GB); Darius Martin SULLIVAN, London (GB)

(21) Appl. No.: 18/604,274

(22) Filed: Mar. 13, 2024

Related U.S. Application Data
(63) Continuation of application No. PCT/EP2022/077768, filed on Oct. 6, 2022.

(30) Foreign Application Priority Data
Oct. 6, 2021 (GB) 2114297.1
May 27, 2022 (GB) 2207876.0

(51) Int. Cl. H04N 13/398; H04N 13/332; H04N 13/383

(52) U.S. Cl. CPC H04N 13/398; H04N 13/383; H04N 13/332

(57) ABSTRACT

A method of displaying a target light field using an image-replicating combiner is described. The method comprises determining a target light field to be displayed at a viewing location; determining a transfer function describing the propagation of light through the image-replicating combiner between the viewing location and an input location near to an input surface of the image-replicating combiner; determining an input light field by applying the determined transfer function to the target light field; and displaying the input light field at the input location. A display system to display a target light field is also described.

### CROSS-REFERENCE TO RELATED APPLICATIONS

This application is a continuation under 35 U.S.C. § 120 of International Application No. PCT/EP2022/077768, filed Oct. 6, 2022, which claims priority to GB Application No. 2114297.1, filed Oct. 6, 2021 and GB Application No. 2207876.0, filed May 27, 2022, under 35 U.S.C. § 119(a). Each of the above-referenced patent applications is incorporated by reference in its entirety.

### BACKGROUND

### Technical Field

The present invention relates to methods and systems for generating and displaying a target light field by an image-replicating combiner. Examples are applied to Computer Generated Holography (CGH).

### Background

Display systems capable of showing images with a continuous range of depths, are collectively known as light field displays. Such displays may broadly employ either the CGH technique or the so-called 4D light field technique. Both techniques typically yield displays with a rather small eyebox. As used herein, an “eyebox” defines pupil positions in which an image can be viewed; the volume in which a viewer's pupil can be positioned to view an image from an image source. In order to view the image, the viewer's pupil must be located within the eyebox, which may be not much larger than the pupil itself. This presents a challenge to align the eyebox with the viewer's pupil.

Some display systems include mechanical adjustment to physically move the eyebox and align it with the viewer's pupil, for example adjusting an Interpupillary Distance (IPD) on a head-mounted display or mechanically adjusting position of a heads-up display so that it can be seen by a viewer. Other displays are custom made for a particular user; the Focals 1.0 commercially available by North® are designed to align the eyebox of the display system with the viewer's pupil following a custom fitting procedure. Such hardware methods are typically not scalable or require significant effort on the part of the viewer in order to correctly align the eyebox with the pupil. Use of the display system by more than one user also requires time consuming re-adjustment or is simply not possible.

Another approach is to enlarge the eyebox using an image-replicating combiner, also known as a waveguide combiner. This expands the eyebox provided by an image source by generating multiple spatially separated replications of the images. The viewer's pupil can then be located in a larger area and still view a complete image. However, image-replicating combiners suffer from reduced image quality due to problems such as focus spread.

It would be desirable to provide an improved method of aligning an eyebox of a display with a viewer's pupil.

### SUMMARY

According to a first aspect of the present invention, there is provided a method of displaying a target light field using an image-replicating combiner, the method comprising: determining a target light field to be displayed at a viewing location; determining a transfer function describing the propagation of light through the image-replicating combiner between the viewing location and an input location near to an input surface of the image-replicating combiner; determining an input light field by applying the determined transfer function to the target light field; and displaying the input light field at the input location.

The transfer function can be determined in any suitable way. In some examples, the transfer function may be calculated or otherwise determined using analytical and/or numerical methods based on knowledge of the properties of the image-replicating combiner, the viewing location and the input location. In other examples, the transfer function can be determined by looking up or using a previously determined transfer function, for the given combination of input location, viewing location and properties of the image-replicating combiner.

Unlike conventional image-replicating combiners, the input light field is determined so that a single target light field is generated with knowledge of a viewing position rather than generating multiple replications and no knowledge of the viewing position. The properties of the image-replicating combiner allow the target light field to be made up of elements of the input light field which have taken different paths through the image-replicating combiner. This allows the position of the target light field to be adjusted in position by changing the input light field. The other replications are still formed by the image-replicating waveguide but are not viewed, therefore it does not matter if these other replications do not accurately reflect the target light field.

The method allows a target light field to be adjusted in position without requiring hardware adjustment or custom fitting (although these may still be present as part of the display system, for example to provide a comfortable fit rather than align an eyebox or to provide broad adjustment with the method providing fine adjustment).

The propagation of light through an optical system may be determined by a transfer function. The transfer function may be the optical transfer function that defines the propagation of a coherent wavefront through an optical system. Alternatively, the transfer function may have the form of a mapping between the rays of an input and output 4d light field, entering and leaving the optical system, respectively.

The result of propagating a light field through an optical system may be calculated by applying the transfer function for the optical system to the light field. Therefore, the term “propagating” may be used synonymously with determining the transfer function and applying it.

The propagating may be between the input location and the viewing location, sometimes referred to as “forward propagating” or in the direction towards the viewing location. The propagating may also be between the viewing location and the input location, sometimes referred to as “reverse propagating”, or “back-propagating”, or in the direction away from the viewing location. This is because the direction of ray propagation is reversible. The propagation can be carried out in any suitable manner, such as through Fourier transform or ray-tracing techniques.

The method may comprise determining that more than one copy of a ray incident on the input surface of the image-replicating combiner is present in the target light field; and omitting the ray from the input light field. This can improve image quality because the additional copy will be perceived as noise or an image artefact by the viewer.

Not all rays with more than one copy may be omitted. For example, the method may comprise: determining that more than one copy of a ray incident on the input surface of the image-replicating combiner is present in the target light field; and determining that at least two copies of the ray are substantially equivalent and retaining the at least two copies of the rays in the input light field. Where rays are substantially equivalent they can be retained without a negative impact on image quality. Examples of substantially equivalent rays include those which have travelled by different paths but have substantially the same path length.

In some examples, rays with more than copy present in the target light field may be selectively retained or omitted. For example, copies of rays that are determined to be substantially equivalent may be retained, and other copies omitted.

The method may comprise determining that a ray, reverse propagated from the target light field to the entrance pupil of the image-replicating combiner, is not present in the input light field; and omitting the ray from the target light field. This can also improve image quality.

When a ray is omitted from the target light field or the input light field, the method may comprise increasing the power of another ray to compensate for the omitted ray. This can increase perceived image quality compared to simply omitting a ray. For example, it can help to maintain a more accurate brightness.

The target light field may be at least as large as a pupil of a viewer at the viewing location. In that case, the likelihood of receiving stray rays from other replications is reduced, increasing image quality.

If an area of the target light field is less than an area of a pupil of a viewer, the method may then comprise expanding the target light field with elements of zero-amplitude such that the expanded target light field has an area at least the size of the pupil. The elements of zero-amplitude act to reduce the undefined rays reaching the viewer's pupil, increasing image quality.

Determining the target light field may comprise: decomposing the target light field into a set of plane waves using a discrete Fourier transform; and applying a padding to the boundary of the target light field, comprising elements of zero-amplitude. Padding the boundary of the target light field reduces potential spurious spill-over from tiled copies during propagation.

The method may comprise determining a position of a viewer's pupil, and wherein the viewing location is the determined position of the viewer's pupil. The determining a position may happen dynamically during viewing, such as by using an eye-tracking system, may be part of an initial calibration process, or may be carried out on demand of the viewer.

The target light field may comprise a plurality of separate light fields each having a respective viewing location and the method may comprise: determining a target light field and determining an input light field for each of the plurality of separate light fields; and combining the input light fields for each of the plurality of separate light fields for display. For example, there may be a separate light field positioned at each of a viewer's pupils and this then enables binocular viewing from a single display. Combining the input light fields can be done in any suitable manner, such as by summation.

The input location may be a surface that is not parallel to the input surface of the image-replicating combiner. This may improve the uniformity of the image as viewed by the eye by minimising the gaps between exit pupil images. In addition, this may improve the resolution of the image as viewed by the eye by minimising the optical path length between neighbouring exit pupil images so that coherence may be maintained across the exit pupil images, even when illumination sources in the image generating unit have low coherence length. The input location surface may be planar or curved, depending on the desired target light field. There are several ways in which the surface at the input location can be non-parallel with the input surface of the image-replicating combiner. This includes one or more of tilting, pitching and/or distorting the input location with respect to the input surface, and rotating the input location surface about an axis parallel to an axis in the plane of the input surface.

When the input location is a surface that is not parallel to the input surface, the method may comprise applying a pre-distortion to the input light field, or as part of the transfer function, to compensate for the distortion introduced by the non-parallel relation. For example, the pre-distortion may be such that a central output replication is displayed substantially without distortion when viewed at the viewing location.

In the above-described methods, the input light field may be a holographic field or a 4-dimensional light field.

When the input light field is a holographic light field and the viewing position is substantially constant, the determining an input light field may use a predetermined constant transfer function based on the propagation between the viewing position and the input location. It has been found that for a constant viewing position a portion of the transformation from the target light field to the input light field is constant, reducing the computational burden and processing resources.

Determining the transfer function may comprise determining that rays received from at least two different replications of the input light field are to form the target light field. For example, one portion of the target light field may be formed from rays from one replication and another portion of the target light field may be formed from rays from another replication. This allows the target light field to have an area which spans two or more replications, so that the target light field can be at an arbitrary position. In some examples, rays from at least two different replications are coincident at a single point on a virtual object. In some examples, rays from at least two different replications are coincident at a single virtual object point.

According to a second aspect, there is provided a display system comprising: an image-replicating combiner; an image generating unit arranged to provide an input to the image-replicating combiner; and a processing system configured to perform the method according to the above-described first aspect, with or without any optional features also described, and to cause the image generating unit to display the input light field.

According to a third aspect, there is provided a display system comprising: an image-replicating combiner having an input surface and an output surface; a display unit for providing an input light field near the input surface; and a processing system. The processing system is arranged to: determine a desired light field for viewing; determine an input light field by propagating through the image-replicating combiner between the desired light field at a viewing position and an input position near the input surface; and cause the display unit to display the input light field. Any of the features of the method of the first aspect can be applied to this third aspect.

Either of the second or third aspects may comprise an eye-tracking system arranged to provide data indicative of the viewing position to the processing system.

In either of the second or third aspects the image-replicating combiner is tuned such that all replications have substantially the same output power for the same input power. This means that the perceived brightness of a ray is substantially the same regardless of the path it took through the image-replicating combiner to the target light field, increasing image quality. Put another way, the output power is substantially the same no matter how many bounces the ray took within the image-replicating combiner.

In either of the second or third aspects, the input location may be a surface that is not parallel to the input surface of the image-replicating combiner. This may improve the uniformity and resolution of the image as viewed by the eye. In either of the second or third aspects, the display system may comprise an optical system positioned in an optical path between the image generating unit and the input surface of the image replicating combiner. The optical system may be arranged to receive an input from the image generating unit and provide the input light field to the input surface such that the input light field is not parallel to the input surface. The optical system may comprise one or more of a grating and a prism.

In some examples the image-replicating combiner might comprise: an in-coupling grating; a redirection grating; and an out-coupling grating. The coupling efficiency of the redirection and out-coupling gratings is configured such that, for a given ray coupled in by the in-coupling grating, each ray extracted at the out-coupling grating is of substantially equal intensity.

The image replicating combiner may be arranged to generate a plurality of replicated images of the input light field, and a gap between neighbouring replicated images is no larger than a diameter of a viewer's pupil. A “gap” refers to a space between replications which is substantially free of rays. For example, replications may be spaced apart from each other so that there is a region between them which is substantially free of rays. Having these gaps may allow greater coverage (as input light is conserved across all replications) and by ensuring the gap is not larger than the size of the viewer's pupil it ensures that for all positions of the viewer's pupil rays are visible. In some examples, a viewer's pupil is assumed to be 4 mm, 4.5 mm, 5 mm, 5.5 mm or 6 mm in diameter and thus a space between directly adjacent replications may be less than or equal to 4 mm, 4.5 mm, 5 mm, 5.5 mm or 6 mm.

The image replicating combiner may be arranged to generate a plurality of replicated images of the input light field, and a combined phase volume of the plurality of replicated images covers the majority of a target phase volume. In some examples, the phase volumes of the replicated images overlap in a small fraction of the target phase volume.

A replication pitch of the image replicating combiner may be greater than half the diameter of a viewer's pupil. As above a viewer's pupil may be assumed to be 4 mm, 4.5 mm, 5 mm, 5.5 mm or 6 mm in diameter, so the replication pitch may be greater than 2 mm, 2.25 mm, 2.5 mm, 2.75 mm or 3 mm. Alternatively, or additionally, a replication pitch of the image replicating combiner may be approximately equal to the width of the input pupil.

The display system may form part of any display where an image is required to be aligned with a viewer's pupil. Examples include a head-mounted display, such as an augmented-reality or virtual-reality headset, and a head-up display, such an automotive heads-up display.

### BRIEF DESCRIPTION OF THE DRAWINGS

FIG. 1 is a schematic representation of phase volumes of 2d light fields;

FIG. 2A is a further schematic representation of phase volumes of 2d light fields;

FIG. 2B is yet a further schematic representation of phase volumes of 2d light fields;

FIG. 3 is a schematic diagram of the operation of a conventional image-replicating combiner;

FIG. 4 is an alternative schematic diagram of the operation of a conventional image-replicating combiner;

FIG. 5 shows an example scene for display;

FIG. 6 shows the example scene displayed through a conventional display system comprising an image replicating combiner;

FIG. 7A is a schematic diagram of a first replication generated by an example image-replicating combiner according to the present disclosure;

FIG. 7B is a schematic diagram of a second replication generated by an example image-replicating combiner according to the present disclosure;

FIG. 7C is a schematic diagram of a third replication generated by an example image-replicating combiner according to the present disclosure;

FIG. 7D is a schematic diagram of an image generated by an example image-replicating combiner according to the present disclosure comprising the three replications shown in FIGS. 7A-7C;

FIG. 8 is a schematic diagram of an image generated by an example image-replicating combiner according to the present disclosure;

FIG. 9 is a schematic diagram of a holographic image generated by another example of an image-replicating combiner according to the present disclosure;

FIG. 10A shows a method of calculating an input light field according to an embodiment;

FIG. 10B shows another method of calculating an input light field according to an embodiment;

FIG. 11 shows a schematic diagram of an example image-replicating combiner transforming an input light field into a target light field;

FIG. 12 is a schematic diagram of the propagation of a ray through an image-replicating combiner;

FIG. 13A shows a first ray not satisfying a first condition for high quality image display using the method of FIG. 10A or 10B;

FIG. 13B shows a second ray not satisfying a second condition for high quality image display using the method of FIG. 10A or 10B;

FIG. 13C shows a third ray not satisfying a third condition required for high quality image display using the method of FIG. 10A or 10B;

FIG. 14A shows a schematic diagram of an example display system illustrating the geometry of replications generated by an image replicating combiner;

FIG. 14B shows a further schematic diagram of an example display system illustrating the geometry of replications generated by an image replicating combiner;

FIG. 14C shows yet a further schematic diagram of an example display system illustrating the geometry of replications generated by an image replicating combiner;

FIG. 14D shows yet a further schematic diagram of an example display system illustrating the geometry of replications generated by an image replicating combiner;

FIG. 15 shows a representation of example paths traversable by rays in an image replicating combiner with the property that the same pairing of input and output ray may be achieved via multiple paths through the combiner;

FIG. 16 a schematic diagram of two target light fields produced by an example image-replicating combiner;

FIG. 17 shows an example image-replicating combiner transforming an input light field into two target light fields;

FIG. 18 shows an example of the replications produced by the image-replicating combiner of FIG. 17;

FIG. 19 is a schematic diagram of a display system according to an embodiment;

FIG. 20 shows an example schematic diagram of an imaging system wherein an image generating unit is tilted with respect to an image-replicating combiner;

FIG. 21 shows an example image displayed without using the techniques described herein; and

FIG. 22 shows the example image displayed using the techniques described herein.

### DETAILED DESCRIPTION

Image-replicating combiners expand the size of the viewable area of an image for a viewer. They comprise an input surface, also known as an in-coupler or an entrance pupil, to receive light rays corresponding to an input image. The notion of an entrance pupil corresponds to the limiting aperture in an input of the image-replicating combiner. The input surface is a coupling feature that couples light waves, propagating externally, to the inside of the image-replicating combiner. The coupling feature may be, for example, an array of mirrors, an array of prisms, a diffraction grating or a hologram. Further possible coupling features include embedded mirrors, micro-prisms, a surface relief slanted grating, a surface relief blazed grating, a surface relief binary grating, a multilevel surface relief grating, a thin volume hologram, a thin photopolymer hologram, a Holographic Polymer Dispersed Liquid Crystal (H-PDLC) volume holographic coupler, a thick photopolymer hologram, a resonant waveguide grating, a metasurface coupler and embedded half-tone mirrors. An image-replicating combiner further comprises an output surface, also called an out-coupler, to output light corresponding to the input image. The output surface is a further coupling feature, which may use the same technology as the input surface. Image-replicating combiners may be manufactured from materials with high-refractive indices that support total internal reflection over a wide range of internal incidence angles. Lanthanum dense flint glass, for example N-LASF46 manufactured by Schott™, has a critical angle of θ_{c}=31° at wavelength λ=530 nm. An image-replicating combiner will propagate waves by total internal reflection at all internal angles above the critical angle.

In an example, an image-replicating combiner takes the form of a substantially planar sheet. The planar sheet may be constructed from a transparent material, such as glass. In this case, one arrangement for the input and output surfaces is to position them on the same side of the planar sheet, such that light enters and exits at the same side of the planar sheet. In another arrangement, the input and output surfaces may be positioned on opposite sides of the planar sheet. The particular arrangement may be selected based on a function of the image-replicating combiner. In other examples, a combiner takes the form of a non-planar sheet. Such combiners may find use as a lens in a pair of spectacles, for example. In non-planar combiners, the input and output surfaces of the combiner may be on the same or opposite sides of the sheet depending on the function of the combiner, as described above.

A feature of image-replicating combiners is that internal rays repeatedly split into reflected and transmitted rays. The etendue of the output ray ensemble is therefore larger than that of the input ensemble. In terms of phase space, the phase volume of possible output ray positions and angles is larger than the phase volume of possible input ray positions and momenta. The inventors have found that it is possible to generate a desired light field, after propagation through an image-replicating combiner, providing the phase volume of the desired light field is no larger than the input light field.

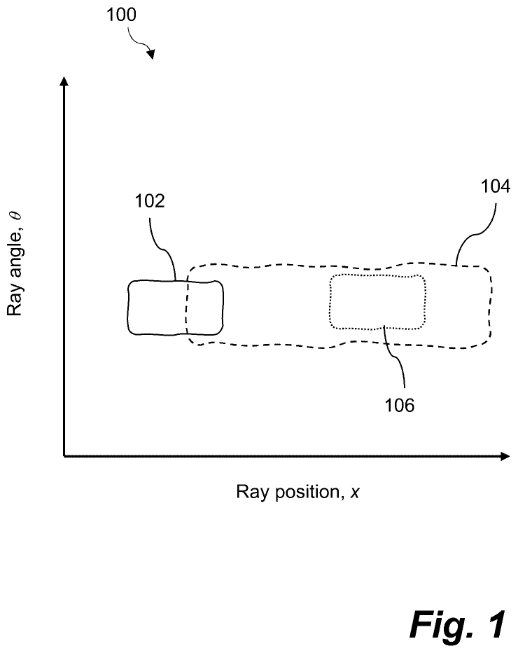

In one example, this means that the maximum valid eyebox and field of view (or more specifically the phase volume) of the output light field, after propagation through a typical, planar, image-replicating combiner, are no larger than the pupil and field of view (or more specifically the phase volume) of the input light field, respectively. The term “valid eyebox” here refers to an eyebox substantially without noise and/or artefacts. This is conveyed in FIG. 1 which is a schematic representation 100 of different phase volumes of 2D light fields, for clarity. Note that FIG. 1 shows a 2D light field with a single spatial and angular dimension, but it can easily be seen how the concept extends to further dimensions, such as a 4D light field, with 2 spatial and 2 angular dimensions. FIG. 1 may be thought of as a 2D cross section of a 4D light field.

Typically, the phase space is 4-dimensional and comprises the two spatial dimensions and two angular dimensions. A phase space representation labels each ray through a given plane with spatial coordinates (representing the point it intersects the plane), and angular coordinates (representing the direction in which it is heading relative to the plane). A light field describes the intensity of each point in this phase space. The input light field spans some volume 102 in phase space (a ‘phase volume’), with the output light field spanning a larger phase volume 104 than the input due to the replication process. Due to the “replicating” phenomena, the second volume 104 appears elongated along the ray position (spatial) axis compared with the first volume 102. The inventors have found that a target light field can be generated whose volume in phase space 106 is no larger than the first volume 102, and which can be targeted anywhere within the second volume 104.

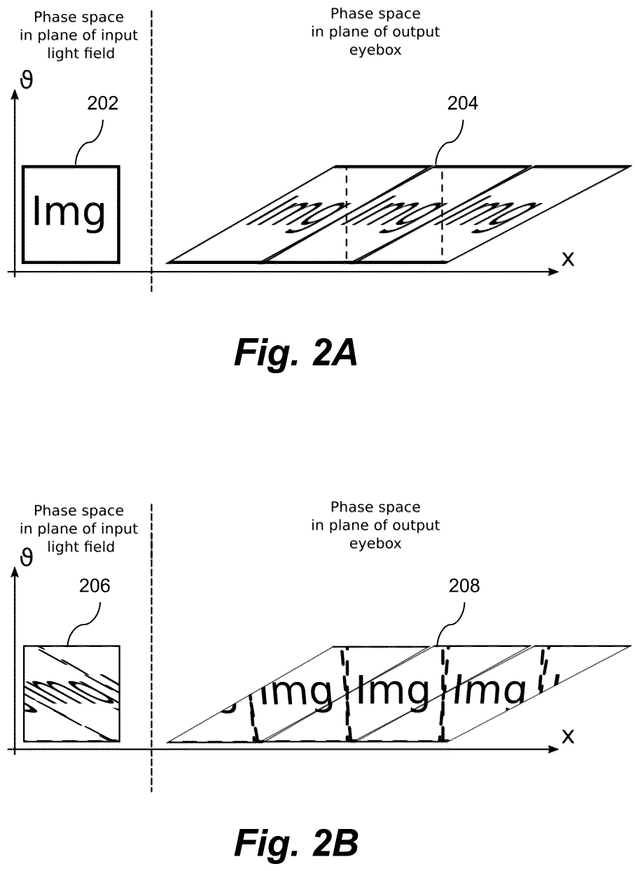

FIG. 2A provides a schematic view of a phase space of a light field 202 incident on the input surface of an image-replicating combiner, and the phase space of the resulting light field 204 exiting the output surface (i.e. the output eyebox). Similarly to FIG. 1, the phase volumes are shown in 2D space (x,θ), for clarity.

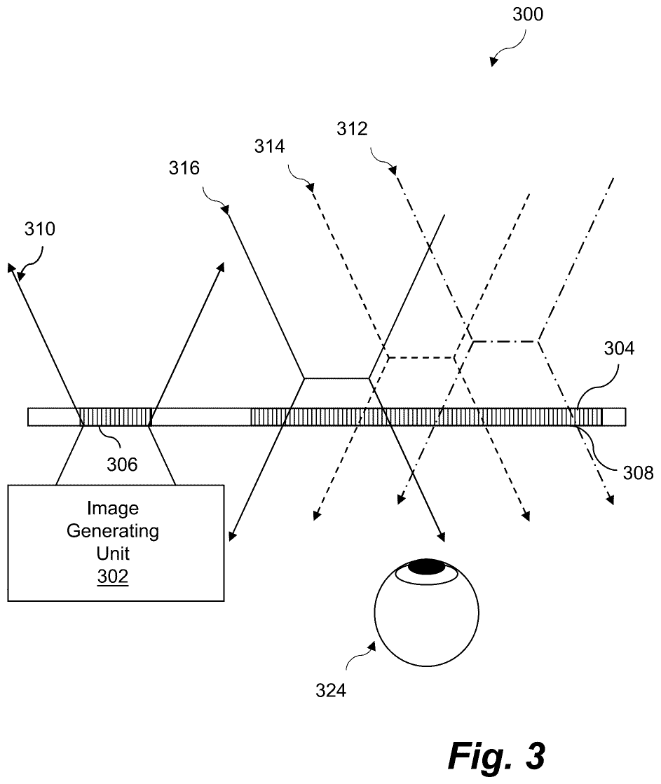

The action of the image-replicating combiner represented in FIG. 2A is to produce multiple copies of an input light field, spatially separated in the x dimension. Additionally, the replications of the input light field are offset in the z direction from the plane of the output eyebox. Furthermore, the different replications are offset in the z direction with respect to one another. This description of a basic image-replicating combiner is shown diagrammatically in FIG. 3.

In the phase space representation, the offset in z corresponds to a shear in the (x, θ) plane, and so the replicated light fields at the output of FIG. 2A can be seen to be sheared in this way. As the replications are also offset from one another in the z direction, the degree of shear is shown to be slightly different for each replication. The size of the phase volumes of the individual output replications are equal to the size of the phase volume of the input light field. The image-replicating combiner may have a replication pitch chosen to minimise overlaps and gaps between the replicated images.

FIG. 2B provides a schematic view of a phase space of a pre-distorted input light field 206, incident on a replicating combiner input surface. The pre-distorted input light field 206 may be calculated according to methods of the present disclosure. In particular, the pre-distortion may be chosen so that the central output replication is correctly displayed in a subset of the phase volume of the output eyebox 208. The input light field may be generated by applying a transfer function to the target light field at the chosen position within the output eyebox.

The input light field 206 is calculated to produce a good quality image at one position and not elsewhere. An eyebox of an image-replicating combiner can be aligned with a viewer's pupil to give a high quality image without the need for custom fitting procedures or mechanical adjustment.

The above descriptions referencing FIGS. 1, 2A and 2B describe the transformation of a 1D replication waveguide on a 2D phase volume for simplicity. However, it is understood that the concepts are straightforwardly transferable to a 2D replicating waveguide and a 4D phase volume. Additionally the concept of a 4D phase volume can be applied to a holographic image as well as a 4D light field, by replacing the concept of ray direction and ray position with the concept of a range of spatial frequencies within a localized region (for example, by replacing each ray with a gaussian beam having the same pointing direction and position as the ray, and expanding a hologram in the basis defined by this set of gaussian beams).

FIG. 3 is a schematic diagram of a conventional display system 300 with an image-replicating combiner 304, to assist understanding of its conventional operation and limitations. The display system comprises an image generating unit 302 configured to generate an input light field 310 and an image-replicating combiner 304 comprising an input surface 306 and an output surface 308. Multiple replications of the input light field 310 are generated at the output surface 308. The image generating unit is preferably arranged such that the exit pupil of the image generating unit 302 coincides with the input surface 306. In FIG. 3, three replications 312, 314, 316 are shown, each corresponding to light that has undergone different numbers of internal reflections within the image-replicating combiner 304.

As can be observed from FIG. 3, light corresponding to the input light field 310 converges on the exit pupil of the image generating unit 302 (by definition). It can be seen that a replicated input pupil forms part of each of the replicated light fields 312, 314, 316. As the light travels beyond the exit pupil and through the input surface of the image-replicating combiner, it diverges. This results in each of the replications 312, 314, 316 diverging on extraction at the output surface 308 of the image-replicating combiner 304. Consequently, a pupil of a viewer's eye 324 aligned with replication 314 will receive also light rays from adjacent replications 312 and 316. As can be further observed from FIG. 3, each of the replications 312, 314, 316 are located at different horizontal positions along the image-replicating combiner 304 resulting in the viewer observing multiple copies of the input light field 310. Each of the replications 312, 314, 316 represent the same input light field horizontally, with respect to the figure, translated. When the image displayed by the image generating unit 302 contains a virtual object at finite depth, a noticeable effect may be observed in the resulting replications due to parallax, wherein the viewer would perceive three (in this example) copies of the virtual object at different perceivable positions. This contrasts with a far-field image, wherein all rays entering the image-replicating combiner 304 appear to emanate from a common point at infinity. Thus, the horizontal distances between successive replications have little effect on the perceivable position of objects in the image. Due to parallax, the difference in position of a virtual object at finite depth in each replication becomes more noticeable as the object is moved closer to the respective pupil. That is, the perceivable effect is a function of the distance of a virtual object from the pupil.

Further, because each replication 312, 314, 316 results from light undergoing different numbers of internal reflections before extraction, and therefore a different optical path length, each replication is perceived as having a different focal depth. In other words, replications 312, 314, 316 appear at different depths and therefore have different apparent sizes. The viewer therefore sees three copies a virtual object within the light field 310 at slightly different depths/sizes resulting in an unsatisfactory viewing experience. This is known as “focus spread”.

To include depth information in an image, for example a CGH image, regions of the image (corresponding to virtual objects within the image) may need to be displayed close to the viewer. In some examples, regions of the image may need to be displayed as close as 100 mm from the viewer. As described above, the display system 300 is not sufficient to generate a satisfactory image. It will be appreciated that unsatisfactory image quality (such as from replicated images of different apparent sizes and perceived position) applies at all depths other than infinity, but has a greater effect the closer the apparent distance of the image region from the viewer. As such, image quality at display depths in the range of 50 mm to 300 mm and further, such as 1 m or 2 m can still suffer from unsatisfactory image quality.

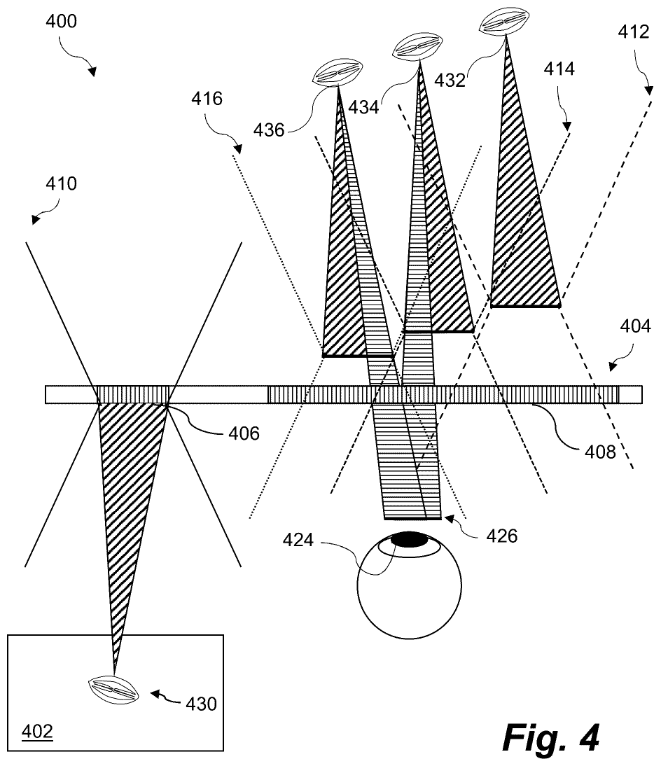

FIG. 4 shows how a naive attempt to display an image at a finite depth through an image-replicating combiner that results in an unwanted double image, by focusing on what happens to rays from a single point on a virtual object in the input light field. The display system 400 is the same as the display system 300 shown in FIG. 3, wherein the reference numbers of corresponding parts start with “4” rather than “3”. The image generating unit 402 is preferably arranged such that the exit pupil of the image generating unit 402 coincides with the input surface 406. A cone of rays (denoted by the oblique hatched area) from a virtual object point 430 in the input light field 410 is shown filling the exit pupil of the image generating unit 402. This is consistent with how a conventional display system operates.

The image-replicating combiner generates replications 412, 414, 416. Each replication corresponds to a replication of the light field at the exit pupil of the image generating unit 402. The display system 400 is shown performing one-dimensional pupil expansion. An image replicating combiner that performs two-dimensional pupil-expansion generates a 2D grid of replicated input pupils and light fields.

Only a subset of the rays from the replicated light fields reaches the eye pupil 424 through the eyebox 426, as denoted by the horizontally hatched areas. The rays reaching the eye pupil 424 come from different replications 416 and 414 and appear to diverge from two separate replicated points 436 and 434 corresponding to virtual object point 430. Two separate images (or “ghosts”) are therefore perceived instead of one single image. There is no inherent limit to the number of replications simultaneously viewable by the eye pupil, so the number of ghost images can be more than two. Note that the oblique hatched areas of the replicated images/light fields are shown truncated at the replicated pupils. Those rays do, of course, propagate from the combiner output surface 408, but they do not reach the eye pupil 424. For instance, rays propagating from the replicated point 432 corresponding to the virtual object point 430 do not reach the eye pupil 424.

In two-dimensionally replicated systems, four or more ghost images may be observed. In many image replicating combiners, the replicated light fields and pupils overlap significantly, as viewed from the eye pupil. In this situation, many more ghost images may be observed.

FIG. 4 illustrates the situation for rays emanating from a single point on a virtual object. Other object points generate different cones of rays, which behave differently. Specifically, different subsets of the replicated rays reach the eye pupil.

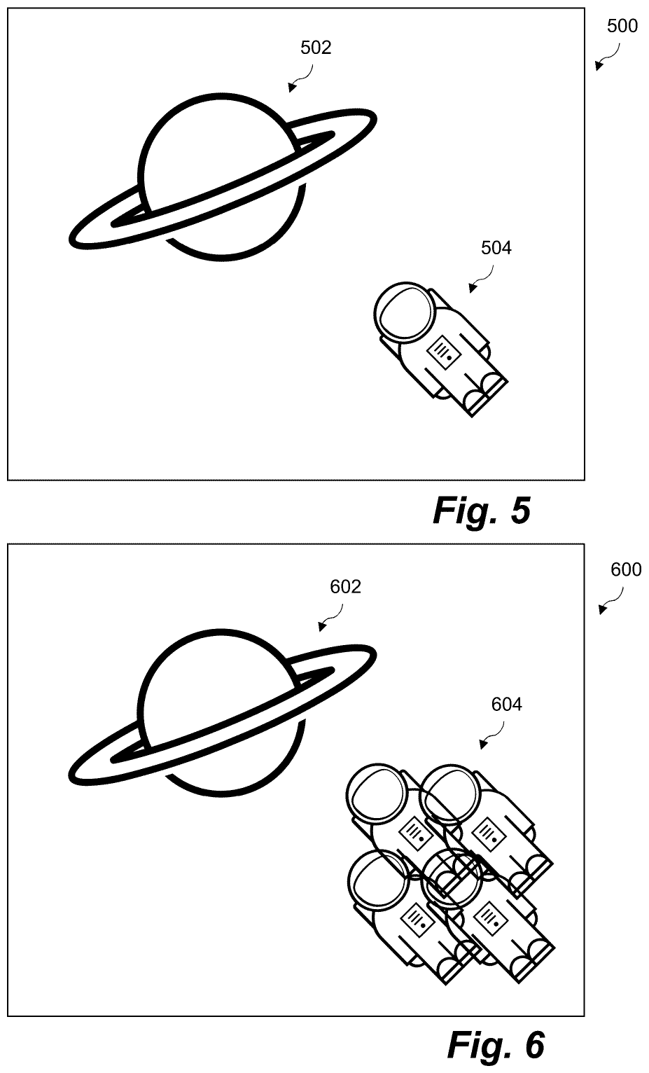

FIG. 5 shows an example scene 500 containing objects at different depths. FIG. 6 shows how this scene may appear when viewed through an image replicating combiner, with the conventional display system shown in FIGS. 3 and 4.

The planet 502 of the scene 500 is an object at infinite depth. Rays emanating from any point on this object are collimated. Therefore, the object is expected to appear correctly when viewed through an image replicating combiner. The astronaut 504 of the scene 500 is an object with finite depth. Rays emanating from any point on this object are uncollimated.

A holographic image generating unit is an example of a system that can display a scene such as this with objects at different depths. When viewed directly with the human eye, the displayed scene is correct and the eye must accommodate differently to view the different objects.

However, the scene 500, which appears correctly under direct viewing, appears incorrectly when viewed through an image replicating combiner. This is illustrated in FIG. 6. In the scene 600, the planet 602 appears correctly because it is placed at infinite depth. The astronaut 604 appears as multiple ghost images because it is placed at finite depth. This is the problem of focus spread that example techniques described herein will address.

It would seem image replicating combiners are a poor choice for expanding the eyebox of CGH images. However, the inventors have found that by controlling the input light field, a targeted light field can be positioned on the viewer's pupil addressing one or more of the problems above.

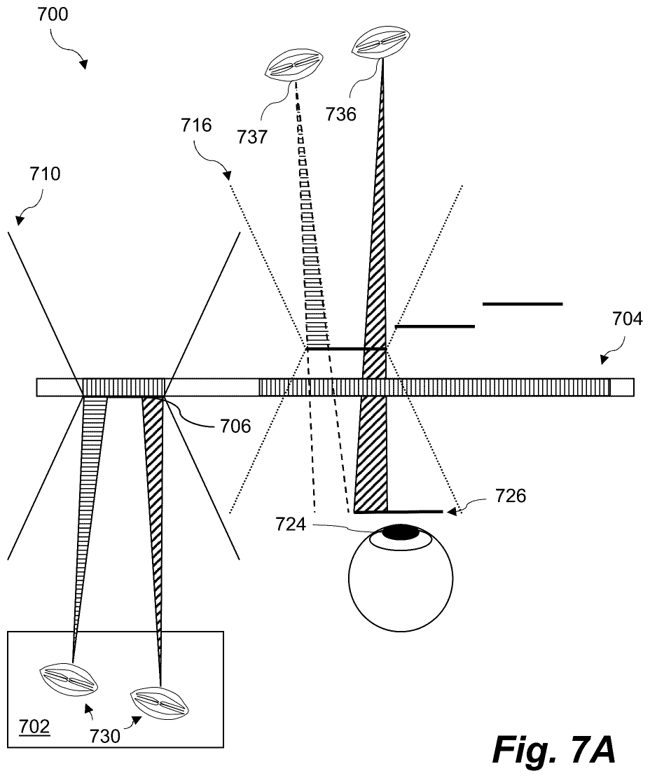

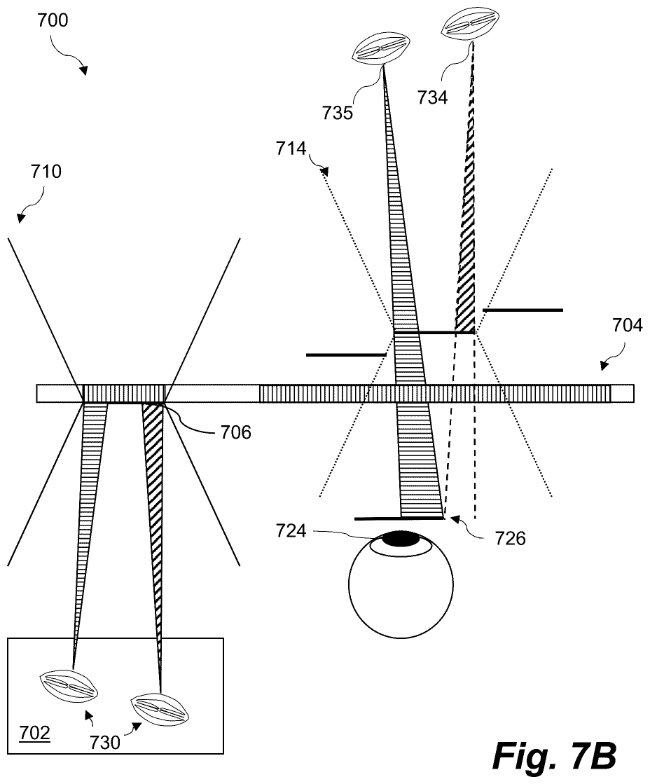

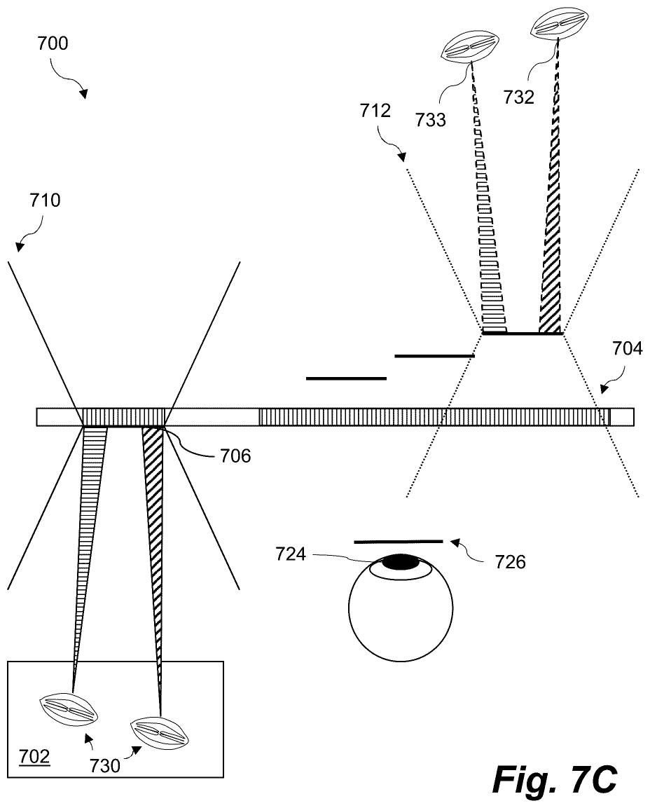

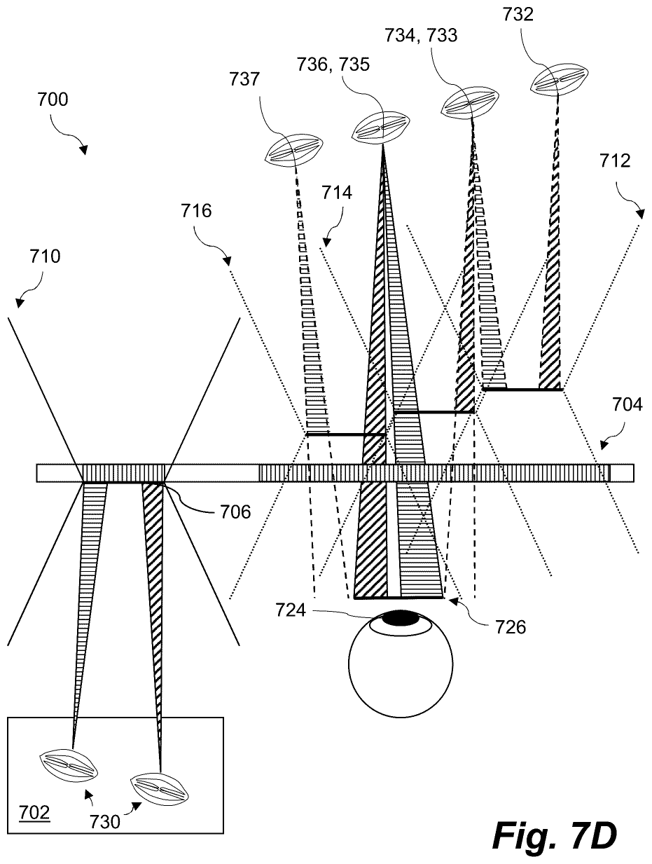

FIGS. 7A-7D show an example display system 700 that illustrates how the input light field from an image generating unit 702 may be configured to display a single point in an image at a finite depth, through an image replicating combiner 704, without ghost images or focus spread.

FIGS. 7A-7C show individual replications of a light field generated by the image generating unit 702. The image generating unit 702 generates a light field in which, in this example, two cones of rays appear to diverge from two points 730. Neither cone of rays fills the exit pupil of the image generating unit 702, which may preferably be arranged to coincide with the input surface 706 of the image replicating combiner 704. The image generating unit 702 must have the capability of controlling not just the location of point sources of virtual objects, but the directions of rays emanating from those sources. Holographic displays and 4D light field displays provide this type of control.

FIG. 7A shows a first replication 716 of the input light field 710. Only the cone of rays diverging from virtual object point 736 and represented by the oblique hatched area, reaches the valid eye box 726 and the eye pupil 724. The dotted lines, from the second cone of rays diverging from a second point virtual object point 737 and represented by the horizontally hatched area, are shown to illustrate how they miss a valid eye box 726 and eye pupil 724.

FIG. 7B shows a second replication 714 of the input light field. In this case, only the cone of rays diverging from virtual object point 735 and represented by the horizontally hatched area, reaches the valid eye box 726 and the eye pupil 724. The dotted lines, from the second cone of rays diverging from a second point virtual object point 734, and represented by the obliquely hatched area, are shown to illustrate how they miss the valid eye box 726 and eye pupil 724.

FIG. 7C shows a third replication 712 of the input light field. In this case, none of the rays from either cone diverging from virtual object points 733, 732 reaches the valid eye box 726 and eye pupil 724.

FIG. 7D shows the combined effect of all three replications shown in FIGS. 7A-7C. It can be seen that, by virtue of the positions of the two points 730, the virtual object points 736 in FIG. 7A and 735 in FIG. 7B are coincident. All the rays reaching the valid eyebox 726 and the eye pupil 724 therefore appear to be diverging from a single point on a virtual object. This illustrates how a single point in a virtual image may be displayed without ghost images or focus spread. The rays appearing to diverge from a single virtual object point comprise rays from multiple replications (in this example, the two replications shown in FIGS. 7A and 7B).

Every virtual object point requires a different set of cones for that point to be displayed correctly. A process for determining the correct light field for scenes containing arbitrary virtual objects will be explained herein.

Note that the image-replicating combiner 704 shown has suitably placed replications to allow the reconstruction of the intended image. That is to say that (i) the replicated image pupils do not significantly overlap but (ii) do not have significant gaps between their full extents. A significant overlap or gap would be comparable to the diameter of the eye pupil. For example, the replicated image pupils may overlap or be separated by gaps less than 4 mm, less than 3 mm, less than 2 mm, less than 1 mm or less than 0.5 mm. In general, image-replicating combiners do not have the first property (i), because it is not required for displaying virtual objects at infinity.

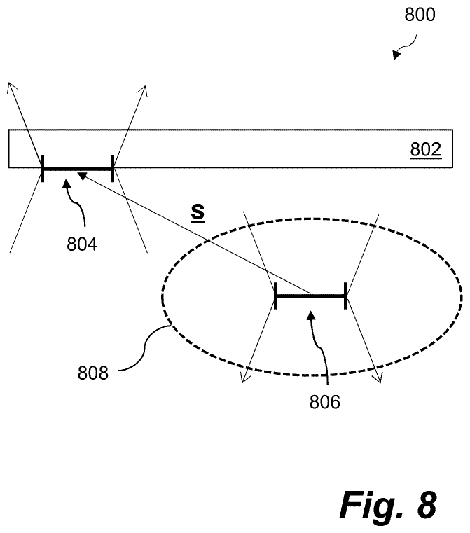

FIG. 8 is a schematic diagram of an example arrangement 800 that addresses the above-mentioned problems of ghosting or focus spread. With such an arrangement 800, it is possible to reproduce the system 700 shown in FIG. 7D. The arrangement 800 comprises an image-replicating combiner 802 in which a light field at the entrance pupil 804 of the combiner 802 has been transformed to a target light field at the valid eyebox 806 of the combiner 802. The valid eyebox can be positioned anywhere in a volume of the addressable eyebox 808, allowing increased freedom in pupil-positioning.

The input light field may be a holographic light field in which depth information in the associated image is represented by phase and/or amplitude modulation of a coherent source. Alternatively, the input light field may be a 4D light field representing the intensity of rays in x, y, θ, φ space.

In this example, the valid eyebox 806 of the combiner 802 is located within a predetermined volume 808 not containing any part of the combiner 802. The centre of the target light field is located at a distance |s| from the centre of the input light field at the entrance pupil 804 of the combiner 802, where s is a three-dimensional displacement vector. Further, the displacement of the target light field may be achieved with no increase in phase volume, so that the etendue of the target light field is the same as the etendue of the input light field.

By predetermining where to locate the target light field based on a generated input light field, properties such as the interpupillary distance (IPD) and vertex distance can be set in software without requiring any mechanical adjustability in a headset comprising the combiner 802. These properties can be set by, for example, a calibration routine using user feedback and/or set automatically via an eye-tracking sensor.

When the input light field is a holographic light field, an image generating unit (not shown) is configured to generate the input light field comprising depth information. The image generating unit includes an at least partially coherent light source, in this case a laser diode, which is configured to illuminate a light modulation element in the form of a spatial light modulator. The laser diode is, for example, a Sumitomo Electric™ SLM-RGB-T20-F-2 laser diode, but other laser diodes may be used. An RGB diode can rapidly switch between emitting different colours of laser light, sequentially emitting red, green, and blue light. By modulating the laser light at different times when the different colours are emitted, the appearance of a colour holographic image may be created for a viewer through persistence of vision. It will be appreciated that other examples may be monochrome or use simultaneous red, green and blue light sources and that the present disclosure is not restricted to a particular light source.

An example spatial light modulator is a Compound Photonics (RTM) DP1080p26 micro-display and configured to adjust the phase of light. By controlling the phase of light, it is possible to use interference to create a holographic light-field image. The present disclosure is not restricted to a particular spatial light modulator technology or component. The holographic replay image is output from the image generating unit at a terminal optical element.

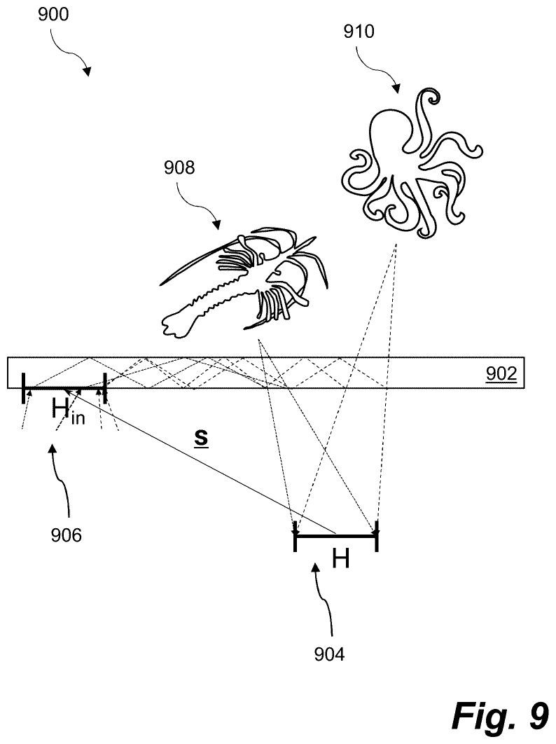

FIG. 9 shows part of an example optical system 900 comprising an image-replicating combiner 902 arranged to generate a 3-dimensional scene for display at a target light field at a valid eyebox 904. In the example optical system 900, an input light field, Hᵢₙ, is generated at an entrance pupil 906 of the combiner 902. As discussed above, Hᵢₙ, may be generated by a suitable image generating unit. It can be seen from FIG. 9 that rays corresponding to a first virtual object 908 at a first depth and a second virtual object 910 at a second depth are produced at the target by determining the form that the input light field Hᵢₙ must take by reverse propagating rays from the target light field through the image-replicating combiner 902. The resultant input light field, Hᵢₙ, appears as a combination of rays that on the face of it do not seem to correspond to the image that is produced at the valid eyebox 904. However, forward propagating the rays through the image-replicating combiner 902 shows that the rays extracted from the combiner 902 do in fact represent the first and second virtual objects 908, 910 at the required depths. It can be seen that rays corresponding to the first and second virtual objects 908, 910 have undergone different numbers of internal reflections within the combiner 902 before extraction from the combiner 902 and arriving at the valid eyebox 904. Further, by ensuring rays forming the target light field satisfy a number of conditions that will be discussed in detail below, the eyebox as viewable to an aligned pupil perceives an image substantially without spurious noise and/or artefacts (hence it is “valid”).

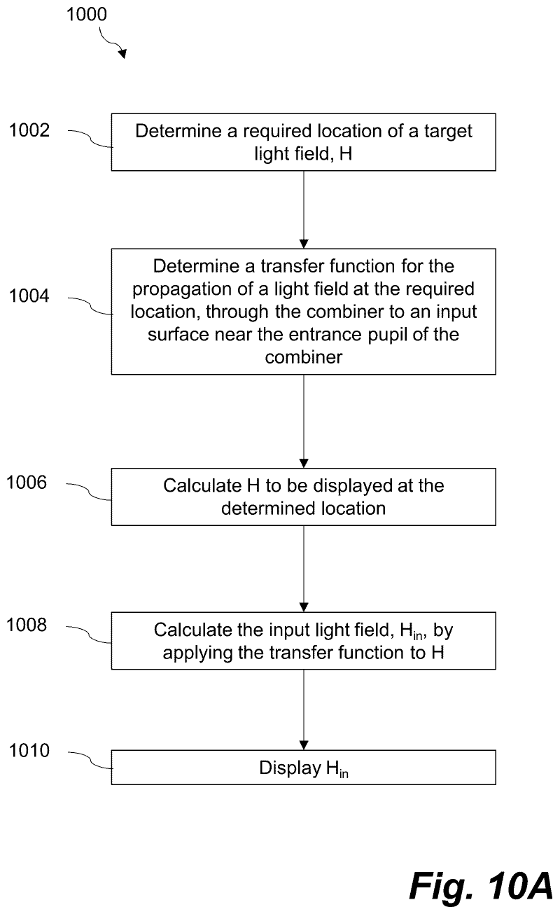

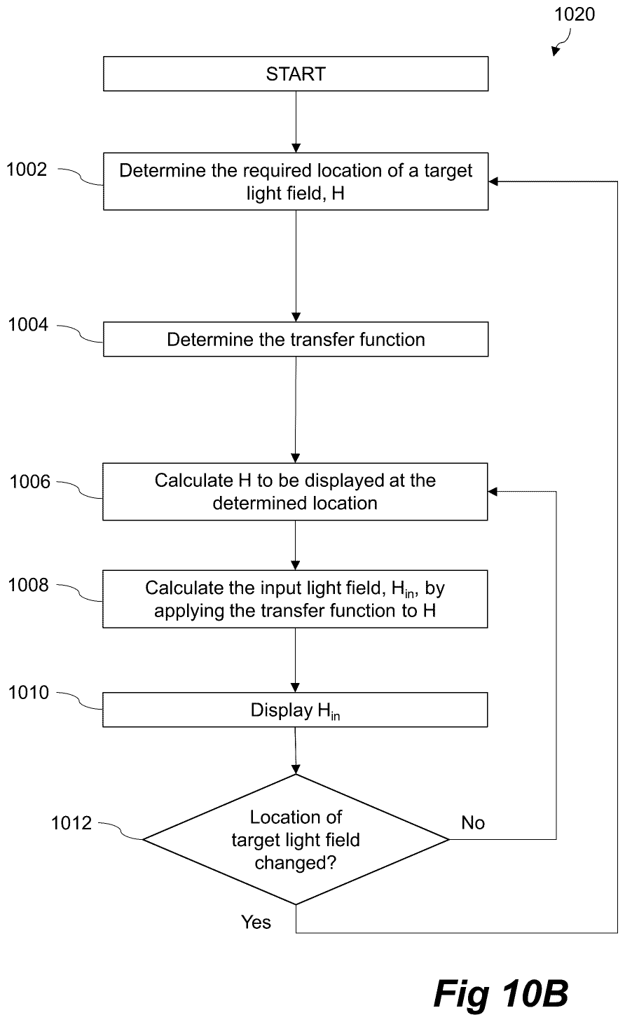

The present disclosure provides methods for determining Hᵢₙ in order to generate a desired target light field (in this case, the holographic light field, H, but it should be appreciated that the present disclosure is not limited to the generation of target holographic fields) at a desired location. An example process of generating the valid eyebox at an arbitrary volume in three-dimensional space will now be discussed in more detail with respect to FIGS. 10-12.

FIG. 10A shows an example method 1000 of transforming an input light field into a target light field within a predetermined volume, as shown in FIGS. 8 and 9. In the present method 1000, Hᵢₙ can be determined by calculating the light field that results from considering the reverse path from the target light field, H, through the combiner 902, to the location of Hᵢₙ.

At block 1002, the method 1000 involves determining the required location (i.e. a valid eyebox) of the target light field, H. This corresponds to determining the displacement vector, s, in FIGS. 8 and 9. This may be set according to a known location of a viewer's pupil. For example, one or more eye-tracking sensors may be used to determine a current 3-dimensional location of the centre of a viewer's pupil. In this case, the eye-tracking sensors generate data indicative of the current location of the centre of the viewer's pupil and relay that data to a computing device. The computing device may be configured to determine the location of H to coincide with the determined location of the centre of the viewer's pupil.

In another example, the required location may be predetermined. For example, the viewer may undergo a calibration routine. This may involve an image generating unit being configured to run through a series of target light fields at various 3-dimensional locations. Each time a target light field in the series of target light fields is displayed, a computing device may ask the viewer whether the image is of acceptable quality. At the end of the calibration procedure, the computing device may determine that the location producing the best image quality, as perceived by the viewer, to be the location at which H should be generated.

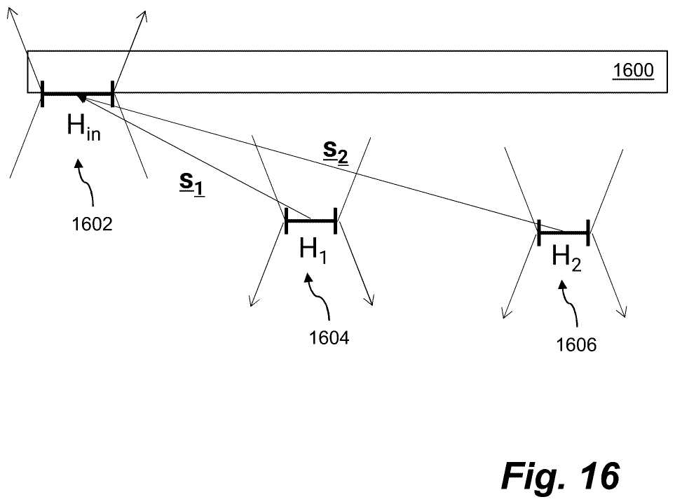

In some examples, the target light field comprises a plurality of light fields (H₁, H₂, . . . ) so that determining the required location of the target light field comprises determining the required location of each of the plurality of light fields. This may be of use in binocular displays wherein only a single image generating unit and image-replicating combiner are required to generate target images at both of a viewer's pupils. This example will be discussed in further detail with respect to FIGS. 16 to 18.

In some examples, block 1002 may be omitted and input of a predetermined position used (for example from an earlier calibration process).

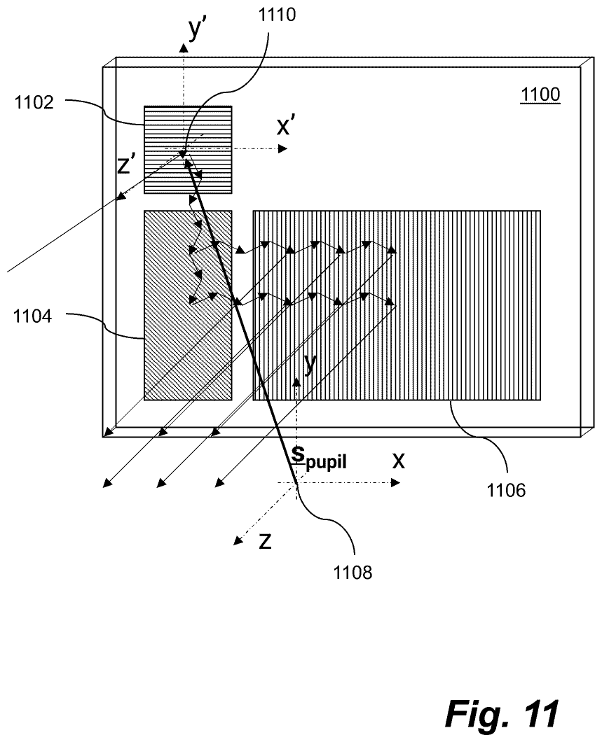

At block 1004, the method 1000 involves determining a transfer function for the propagation of a light field at the required location, through the combiner to an input surface near the entrance pupil of the combiner. Block 1004 will be discussed in detail by referring now to FIG. 11, which shows an example image-replicating combiner 1100. The specifications of the image-replicating combiner 1100 are determined by the physical requirements for the display system. For example, the image-replicating combiner 1100 should be able to support total internal reflection over a wide range of internal incidence angles. Lanthanum dense flint glass, for example N-LASF46 manufactured by Schott™, has a critical angle of θc=31° at wavelength λ=530 nm. An image-replicating combiner will propagate waves by total internal reflection at all internal incident angles above the critical angle.

The image-replicating combiner 1100 comprises an in-coupling grating 1102, also known as an input surface or in-coupler, to receive an input light field corresponding to a holographic image. The in-coupling grating 1102 represents a surface relief grating such that free space waves are coupled into the combiner 1100 at the in-coupling grating 1102 by diffraction. A surface relief grating with a groove frequency of 2580 lines/mm can serve as an input or output coupler between free space and total internal reflection within N-LASF46. More complex surface relief gratings may be manufactured that exhibit optical power in addition to simple diffraction from parallel equally spaced linear grooves.

The image-replicating combiner 1100 further comprises an out-coupling grating 1106, also known as an output surface or out-coupler, to generate a plurality of replications of the input light field. The image-replicating combiner 1100 further comprises a redirection grating 1104, also known as an exit pupil expander, arranged to redirect light undergoing internal reflections from the in-coupling grating 1102 towards the out-coupling grating 1106.

The image-replicating combiner 1100 in this example has the in-coupling grating 1102, the redirection grating 1104 and the out-coupling grating 1106 all on the same face. This means that all internal rays traverse the combiner an even number of times before redirection by the redirection grating (if any), and also before exiting the combiner, as demonstrated by the ray incident at 1110. Other embodiments may have either or both the in-coupling grating and the redirection grating on the face opposite to the out-coupling grating. In these cases, internal rays may traverse the combiner an odd number of times before redirection by the redirection grating, and/or before exiting the combiner.

The example of FIG. 11 shows an image-replicating combiner that operates with that incident rays on the in-coupler 1102 and output rays from the out-coupler 1106, all on the same side of the combiner (i.e. the positive z-direction). In some configurations the incident rays may enter the combiner from the negative z-direction, i.e. the opposite side to where they emerge at the out-coupler grating. The optimal choice of configuration is often determined by constraints in the overall layout of the optical system.

Although in the example of FIG. 11, the image-replicating combiner 1100 comprises gratings as coupling features, it is appreciated that other types of coupler are possible. For example, the in-coupler to an image-replicating combiner may comprise a mirror, a prism, or a hologram. It will also be appreciated that other examples can use other forms of image-replicating combiner, including curved or non-planar designs.

A typical image-replicating combiner, comprising couplers in the form of gratings such as that in FIG. 11, is characterised by: a set of grating k-vectors parameterised by k_{grating}, the thickness of the combiner, t, and the refractive index of the material comprising the combiner, n. The grating k-vectors describe how the in-coupling, redirection, and out-coupling gratings affect light waves incident on the respective gratings. In the example image-replicating combiner 1100 shown in FIG. 11, the grating k-vectors for each of the gratings are the following:

$$\\ In ‐ coupling grating , \underline{k} {}_{in} = ( 0 , - {k}_{grating} , 0 ) ,$$

$$\\ Redirection grating , \underline{k} {}_{redirection} = ( {k}_{grating} , {k}_{grating} , 0 ) ,$$

$$\\ Out ‐ coupling grating , \underline{k} {}_{out} = ( - {k}_{grating} , 0 , 0 ) .$$

In simple terms, the in-coupling grating redirects the rays downwards (towards the redirection grating in FIG. 11). The redirection grating then redirects the rays horizontally to the right and cancels the vertical redirection. Finally, the out-coupling grating cancels the horizontal redirection on extraction from the combiner.

The coupling efficiency of the redirection and out-coupling gratings 1104, 1106 can be tuned such that, for a given ray coupled in by the in-coupling grating 1102, each ray extracted at the out-coupling grating 1106 is of approximately equal intensity.

Further, the described properties of the image-replicating combiner 1100 are such that for a ray incident on the in-coupling grating 1102 with k-vector (kₓ, k_{y})=(0, 0), rays in the combiner 1100 are at an angle having sin θ=k_{grating} λ/2πn, resulting in a replication pitch (spacing between nearest neighbouring input-pupil replications) of 2t tan θ.

In the example shown in FIG. 11, the origin of the co-ordinate system 1108 is positioned at the location of the target light field, determined at block 1002. With this definition, the entrance pupil of the image-replicating combiner 1100 is located at a location sₚᵤₚᵢₗ=(xₚᵤₚᵢₗ, yₚᵤₚᵢₗ, zₚᵤₚᵢₗ) relative to the determined location of H. As discussed above, Hᵢₙ can be calculated by reverse-propagating H (determined at block 1004) from the determined location (determined at block 1002), through the combiner 1100, to the entrance pupil. The holographic target light field, H, may be represented by a complex electric field strength A(x,y)e^{i(φ(x,y)-ωt)}. In practice, the oscillatory time-dependence can be ignored, and instead, it is usual to define a full-complex hologram having amplitude A(x,y) and phase φ(x,y). The target light field, H, can be decomposed into plane waves of infinite extent using a Fourier Transform (FT), evaluated in the plane z=0, in order to eliminate k_{z}. For evaluation of H outside of this plane, k_{z} is defined implicitly as a function of kₓ and k_{y} by the constraint

$$\\ \vert k \vert = \frac{2 π n}{λ} ,$$

where n is the refractive index of the medium, and λ is the wavelength of the field in a vacuum.

The target light field, H, at position (x, y, z) can therefore be evaluated according to Equation 1.

$$\\ \begin{matrix}H ( x , y , z ) = {\int }_{{k}_{y min}}^{{k}_{y max}} {\int }_{{k}_{x min}}^{{k}_{x max}} \hat{A} ( {k}_{x} , {k}_{y} ) {e}^{{}_{} i \hat{φ} ( {k}_{x} , {k}_{y} )} {e}^{{}_{} i ( {k}_{x} x + {k}_{y} y + {k}_{z} z )} {dk}_{x} {dk}_{y} . & Equation 1\end{matrix}$$

In this case, the limits on the integrals ensure that H is defined such that the coefficients for k's less than kₘᵢₙ or greater than kₘₐₓ are zero. This is equivalent to bounding the field of view of the hologram. In practise this decomposition is performed as a discrete Fourier Transform, where the integral is replaced with a sum over discrete values of k. This results in a tiling of H, so H may be padded with zeros prior to the Fourier decomposition to avoid spurious spill-over from tiled copies during propagation.

The value of k_{z} for the path from the origin of the co-ordinate system 1108 to out-coupling grating 1106, denoted k_{z0}, can be evaluated using the relationship

$$\\ \vert k \vert = \frac{2 π n}{λ} ,$$

as described above. With this, the target light field H can be propagated a distance zₚᵤₚᵢₗ along the z axis from the origin of the co-ordinate system 1108 to the out-coupling grating 1106, which can be achieved by substituting zₚᵤₚᵢₗ into Equation 1.

At the out-coupling grating 1106, the effect of the grating, represented by the k-vector kₒᵤₜ, is applied in order to couple H to the combiner 1100. This corresponds to substituting the x and y components of the light field wavevector, k, with those from k+kₒᵤₜ, then evaluating the k-vector at the out-coupling grating 1106 denoted k_{z1}, again using the relationship

$$\\ \vert k \vert = \frac{2 π n}{λ} .$$

With the light field evaluated at the out-coupling grating 1106, the light field can be propagated along the z axis a distance −2nₓt, where nₓ is the number of internal traversals in the combiner between the out-coupling grating 1106 and the redirection grating 1104.

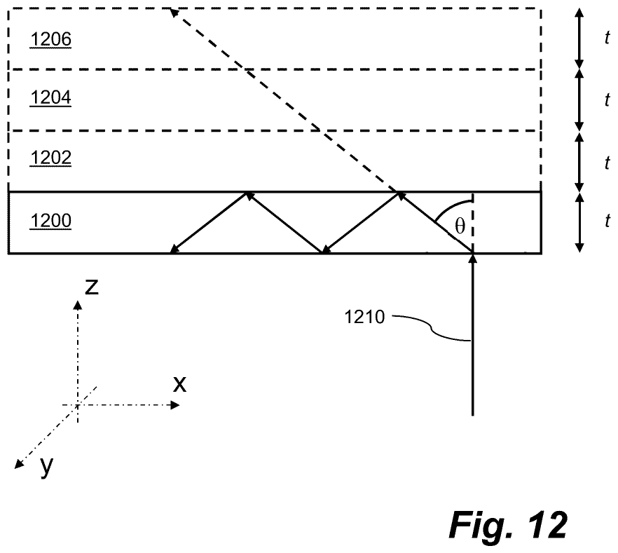

Propagating a distance along the z axis through the image-replicating combiner 1100 can be seen by considering the equivalent situation wherein the light field does not undergo any internal reflections. This situation will now be discussed with regards to FIG. 12 which shows an example of a ray propagating through an image-replicating combiner 1200 having a thickness, t, and a coupling grating having a grating k-vector parameterised by kᵢₙ. A ray 1210 with a component in the z-direction is incident on the coupling grating in a direction normal to the grating. The ray 1210 is coupled to the combiner 1200 by the coupling grating. On entering the combiner 1200, the ray 1210 is deflected to an angle θ relative to the lower surface normal of the combiner 1200, wherein sin θ=kᵢₙ λ/2πn. θ is the angle between the ray and the normal of the lower surface of the combiner 1200. The ray travels a distance t in the z-direction and a distance t tan θ in the negative x-direction, at which point it undergoes a first internal reflection against the inner surface of the combiner 1200 according to the law of reflection. In reality, the ray travels back towards the surface at which the ray entered the combiner 1200, but this is mathematically equivalent to the ray continuing to travel along in the positive z-direction into an imaginary volume 1202 stacked on top of the combiner 1200 and having the same geometric properties as the combiner 1200. As shown in FIG. 12, an imaginary ray continuing to travel in the positive z-direction is shown as a dotted arrow travelling through successive imaginary volumes 1202, 1204, 1206. Each time the imaginary ray crosses a horizontal internal boundary of an imaginary volume 1202-1206, it is equivalent to the actual ray undergoing an internal reflection within the combiner 1200. In other words, the imaginary ray having crossed 2n horizontal boundaries is equivalent to the actual ray having made 2n traversals of the combiner. Therefore, after 2n traversals of the combiner the ray has travelled a distance of 2t in the z-direction.

Applying this logic to the example shown in FIG. 11 confirms that the ray reaches the redirection grating 1104 after it has travelled a distance −2nₓt along the z axis. At the redirection grating 1104, the effect of the grating is applied to the light field, represented by the k-vector k_{redirection}. This corresponds to substituting the x and y components of the light field wavevector, now evaluated at the redirection grating and denoted k₁, with those from k′+k_{redirection}, and evaluating k_{z2} using the relationship

$$\\ \vert k \vert = \frac{2 π n}{λ} ,$$

as described above with respect to k_{z1}.

The light field is then propagated along the z-axis a distance −2n_{y}t, where n_{y} is the number of internal traversals of the combiner 1100 between the in-coupling grating 1102 and the redirection grating 1104 using the same logic that is shown in FIG. 12. At the in-coupling grating 1102, the effect of the grating is applied to the light field represented by the k-vector kᵢₙ. This corresponds to substituting the x and y components of the light field wavevector, now evaluated at the in-coupling grating and denoted k₂, with those from k″+kᵢₙ, and evaluating k_{z3} using the relationship

$$\\ \vert k \vert = \frac{2 π n}{λ} ,$$

as described above with respect to k_{z1}.

The process above has propagated the target light field, H, to the entrance pupil of the combiner 1100 in the z-direction only. To complete the propagation of the light field in the x- and y-directions, the light field is propagated a distance (xₚᵤₚᵢₗ, yₚᵤₚᵢₗ, 0) to the entrance pupil of the combiner 1100.

As described so far, the propagation of a set of plane waves from a viewer's pupil have been considered. The set of plane waves have been propagated through the combiner 1100 along a defined path (set by the number of internal reflections between each grating) and to the entrance pupil of the combiner 1100. For the full solution, it is necessary to sum over all possible routes through the combiner 1100, limited to values of nₓ, n_{y} and wherein Hᵢₙ has an energy exceeding some threshold within the bounds of the entrance pupil of the combiner 1100.

The sum over possible routes may be coherent or incoherent, depending on factors such as: the coherence length of the illumination and the differences in optical path length between paths of different nₓ, n_{y}.

If the coherence length is much larger than the differences in path length, the contributions will sum coherently. The complex amplitudes of the different paths are added together, and interference effects are possible between the different nₓ, n_{y} contributions.

If the coherence length is much smaller than the differences in path length, the contributions will sum incoherently. The complex amplitudes of the different paths are effectively multiplied by time-varying random phase factors before summation. The phase factors may vary quickly relative to the perception time of the human eye, so interference effects between the different nₓ, n_{y} contributions are not observed.

The full solution for Hᵢₙ, in the coherent case, is given by Equation 2.

$$\\ \begin{matrix}{H}_{in} ( {x}^{{}_{} ′} , {y}^{{}_{} ′} , {z}^{{}_{} ′} ) = {\sum }_{{n}_{x}} {\sum }_{{n}_{y}} {{\int }_{{k}_{y min}}}^{{k}_{y max}} {{\int }_{{k}_{x min}}}^{{k}_{x max}} \hat{A} ( {k}_{x} , {k}_{y} ) {e}^{{}_{} i \hat{φ} ( {k}_{x} , {k}_{y} )} {e}^{{}_{} i ( {k}_{x} {x}^{{}_{} ′} + {k}_{y} {y}^{{}_{} ′} + {k}_{z} {z}^{{}_{} ′} )} {e}^{{}_{} i ( \underline{k} \cdot \underline{s} {}_{pupil} - 2 t ( {n}_{x} {k}_{z 1} + {n}_{y} {k}_{z 2} ) )} {dk}_{x} {dk}_{y} . & Equation 2\end{matrix}$$

The primed co-ordinates x′, y′, z′ are defined relative to the entrance pupil so that the origin of the primed co-ordinate system 1110 is related to the origin of the unprimed co-ordinate system 1108 by the displacement vector sₚᵤₚᵢₗ. Equation 2 could therefore be written in terms of the unprimed co-ordinate system using an appropriate co-ordinate transformation.

As described above, Equation 2 represents a required light field to be generated at the entrance pupil of the combiner 1100 in order to generate the target light field, H, at the determined location. The computation may be performed in software, in which case the integrals become summations. The computation could be performed each time a new target light field, H, is required to be displayed, such as a new video frame or new information on a generally static display.

The determination of the transfer function by the calculation described above may involve determining that rays received from at least two different replications of the input light field form respective portions of the target light field. In other words, part of the target light field, H, may be formed from one replication and another part of H may be formed from another replication. This can be seen, for example, in FIG. 7D wherein the light that reaches the viewer's pupil 724 comprises light from different replications of the virtual object 730.

In the example above, the input coupler 1102 and output coupler 1106 share the same face of the combiner 1100. If the input and output couplers are placed on the opposite faces of the combiner, it is necessary to define sₚᵤₚᵢₗ as the displacement between: (i) the centre of the target light field and (ii) the point on the output-coupler combiner face nearest the centre of the entrance pupil.

In a system where the input coupler, redirection coupler and output coupler do not share the same combiner face, the optical path length between couplers may be defined by an odd number of traversals of the combiner. In this situation it may be necessary to substitute nₓ for (nₓ+½) and/or n_{y} for (n_{y}+½) in the exponent of Equation 2, so that the correct number of combiner traversals are counted.

Referring back to FIG. 10A, at block 1006, the method 1000 involves calculating the target light field, H, to be displayed at the determined location. That is, the properties of the target light field are determined in order to generate a desired image at the determined location. In the example shown in FIG. 9, determining H comprises determining properties of the light field in order to produce the first and second images 908, 910 at the respective depths. The skilled person is aware of techniques to determine this image.

It will be appreciated that blocks 1002 and 1006 can occur in any particular order. In the example method 1000, determining the location of the target light field occurs before calculating the target light field. However, it is also possible to first calculate a target light field and then determine a location at which to display the target light field.

At block 1008, the method 1000 involves calculating the input light field, Hᵢₙ, by applying an optical transfer function to the target light field, H. That is, using Equation 2 to determine Hᵢₙ.

At block 1010, the method 1000 involves displaying the input light field, Hᵢₙ, using an appropriate display. If the target light field is a holographic light field, then Hᵢₙ is generated using an image generating unit configured to generate holographic light fields. In the example shown in FIG. 11, H is a holographic light field, so generating Hᵢₙ involves using an image generating unit to generate a light field corresponding to Hᵢₙ at the entrance pupil of the combiner 1100. If His a 4D light field, then Hᵢₙ can be generated using a suitable 4D light field generator. One such suitable 4D light field generator is described in “Near-eye light field displays”, Lanman et al., available from https://research.nvidia.com/sites/default/files/pubs/2013-11_Near-Eye-Light-Field/NVIDIA-NELD.pdf, published 1 Nov. 2013 and first archived by web.archive.org on 14 Nov. 2020. The Lanman 4D light field generator consists of an OLED microdisplay and an intermediate microlens array between the microdisplay and the viewer's eye.

Referring back to Equation 2, it is possible to rewrite this expression as shown in Equation 3.

$$\\ \begin{matrix}{H}_{in} ( {x}^{{}_{} ′} , {y}^{{}_{} ′} , {z}^{{}_{} ′} ) = {\int }_{{k}_{y min}}^{{k}_{y max}} {\int }_{{k}_{x min}}^{{k}_{x max}} \hat{A} {}_{in} ( {k}_{x} , {k}_{y} ) {e}^{{}_{} i \hat{φ} {}_{in} ( {k}_{x} , {k}_{y} )} {e}^{{}_{} i ( {k}_{x} {x}^{{}_{} ′} + {k}_{y} {y}^{{}_{} ′} + {k}_{z} {z}^{{}_{} ′} )} {dk}_{x} {dk}_{y} . & Equation 3\end{matrix}$$

$$\\ wherein$$

$$\\ \begin{matrix}{\hat{A}}_{in} ( {k}_{x} , {k}_{y} ) {e}^{{}_{} i \hat{φ} {}_{in} ( {k}_{x} , {k}_{y} )} = \hat{A} ( {k}_{x} , {k}_{y} ) {e}^{{}_{} i \hat{φ} ( {k}_{x} , {k}_{y} )} {\sum }_{{n}_{x}} {\sum }_{{n}_{y}} {e}^{{}_{} i ( \underline{k} \cdot \underline{s} {}_{pupil} - 2 t ( {n}_{x} {k}_{z 1} + {n}_{y} {k}_{z 2}^{} ) )} . & Equation 4\end{matrix}$$

That is, the order of summation and integration can be swapped, and the additional propagation terms can be absorbed into a newly defined set of Fourier coefficients. In particular, the summed portion of Equation 4 is the optical transfer function and can be evaluated independently of the Fourier coefficients of Hᵢₙ, so only needs to be recalculated if sₚᵤₚᵢₗ changes. This is particularly useful when the determined location of the target light field (at block 1002) rarely changes, or is fixed completely, as a function of time. In these cases, the number of computations is reduced, and the efficiency of the process is improved.

The planes of the input and target light fields may be parallel to each other but not parallel to the input and output couplers of the combiner. In the case that the combiner is rotated angle α around the x-axis and angle β around the y-axis of the input and target light fields, the rotated wavevector, k′, in the local coordinate system of the combiner, is defined as follows:

$$\\ {k}^{{}_{} ′} = ( \begin{matrix}{k}_{x}^{{}_{} ′} \\ {k}_{y}^{{}_{} ′} \\ {k}_{z}^{{}_{} ′}\end{matrix} ) = ( \begin{matrix}0 & 0 & 0 \\ 0 & cos α & sin α \\ 0 & - sin α & cos α\end{matrix} ) ( \begin{matrix}cos β & 0 & sin β \\ 0 & 0 & 0 \\ - sin β & 0 & cos β\end{matrix} ) ( \begin{matrix}{k}_{x} \\ {k}_{y} \\ {k}_{z}\end{matrix} )$$

In this case, Equation 4 is modified by substituting wavevectors k, in the summed term, with rotated wavevectors k′. This is shown in Equation 5.

$$\\ \begin{matrix}{\hat{A}}_{in} ( {k}_{x} , {k}_{y} ) {e}^{{}_{} i \hat{φ} {}_{in} ( {k}_{x} , {k}_{y} )} = \hat{A} ( {k}_{x} , {k}_{y} ) {e}^{{}_{} i \hat{φ} ( {k}_{x} , {k}_{y} )} {\sum }_{{n}_{x}} {\sum }_{{n}_{y}} {e}^{{}_{} i ( \underline{{k}^{{}_{} ′}} \cdot \underline{s} {}_{pupil} - 2 t ( {n}_{x} {k}_{z 1}^{{}_{} ′} + {n}_{y} {k}_{z 2}^{{}_{} ′} ) )} . & Equation 5\end{matrix}$$

In the example shown in FIG. 11, the image-replicating combiner 1100 takes the form of a rectangular planar sheet. However, the present disclosure is not restricted to image-replicating combiners having any particular shape. In particular, method 1000 is applicable in the case when the combiner is non-planar. In this case, calculating the input light field by reverse-propagating the target light field through the combiner is done analogously to the way that Hᵢₙ has been calculated with respect to the example discussed with respect to FIG. 11, but with considerations made for the particular geometry of the combiner.

Further, although calculating an input light field has been discussed with regards to calculating a holographic light field, the present disclosure is not tied to holography. In particular, using the present disclosure, it is possible to calculate an input 4D light field in order to generate a desired target 4D light field at a determined location. A 4D light field specifies the intensity of light as a function of x, y, θ, φ, wherein x, y are spatial coordinates at the location of the centre of a viewer's pupil, and θ, φ are angular coordinates of light at that location. Propagation through a combiner (such as the combiner 1100) entails a remapping of 4D phase space; each ray having a value of x, y, θ, φ at H has a unique corresponding ray having values x′, y′, θ′, φ′ at Hᵢₙ. This mapping can be determined using standard ray-tracing techniques. However, a typical light field display will sample coarsely in x, y and densely in θ, φ, as these set the apparent resolution of the display. This sparse sampling of x, y at Hᵢₙ may appear as image artefacts at H, so a holographic light field may have higher image quality.

The method 1000 can be used to calculate an input light field required to generate a target light field at a desired location. In some examples, the desired location may change as a function of time. For example, one or more eye-tracking sensors may be used to determine the required location of H at block 1002 based on the location of a viewer's pupil in real time. The eye-tracking sensors may generate live data about the current location of a viewer's pupil and relay this to a computing device. The computing device may then determine s such that the target light field is required to be generated at the current location of the centre of the viewer's pupil. In practice, the viewer may move their eyes based on a number of factors such as a change in position of an object of interest in the image that is currently being displayed, a change in brightness of the displayed image, and movement of the user themselves as they are viewing the image. In this case, the required location of His a function of time, s(t), and the determined required location of H changes accordingly as a function of time.

In other examples, the determined location of the target light field may be based on an initial calibration. An advantage of displaying the target light field at a fixed position is that the expression in Equation 4 is dependent only on terms evaluated at the determined fixed position, and so only needs to be calculated once. This improves efficiency of the process allowing for higher framerates and/or higher resolutions with the same processing resources or reduced power operation. The downside of this is that, because the position of the displayed target light field is fixed, movement of the viewer's pupil may cause at least part of the target light field not to overlap with the current area occupied by the viewer's pupil.

FIG. 10B shows another example method 1020 of transforming an input light field into a target light field within a predetermined volume, as shown in FIGS. 8 and 9. The method 1020 is similar to the method 1000 in that it also includes blocks 1002-1010 of the method 1000. In the example method 1020, after the displaying the input light field, Hᵢₙ, block 1012 involves determining whether the location of the target light field is to be changed. For example, it may be determined that the target light field is to be displayed at a different location. This could be based on determining that a viewer's pupil has moved so that the target light field should be relocated to the new pupil location, for example.

If it is determined at block 1012 that the location of the light field is to be changed, the method 1020 returns back to block 1002 wherein an updated location of a target light field is determined, followed by determining the transfer function for that updated location at block 1004.

If it is determined at block 1012 that the location of the light field is not to be changed, then the method 1020 returns to block 1006 wherein the target light field is (re-) calculated to be displayed at the required location.

In the method of FIG. 10B, the decision at block 1012 therefore determines whether a transfer function should be updated because a viewing location has changed. In other examples, the target light field to be displayed may also change in consecutive loops of the method 1020. For example, the input light field may be recalculated at block 1008 if the location of the target light field has changed, in which case a new transfer function is determined at block 1004 and applied to the target light field. Alternatively, or in addition, the input light field may be recalculated if there is a change of data for display. For example, the display system may be configured to display video content, so that each loop of the method 1020 (either from 1002 to 1012 or from 1006 to 1012) may correspond to the display of a single frame of the video content. Each time the method 1020 proceeds to block 1006, there may a new frame with a corresponding new target light field. At block 1008, the input light field is calculated by applying the transfer function to the target light field. The transfer function may have been redetermined based on a change of location of the target light field. Thus, the method 1020 can be used in a video update loop in which both the target light field is changed on a frame per frame basis and the location of the target light field may be changed as the viewing location changes.

In another example, the display system may display a static image, so that the target light field may not change between these loops and in that case some examples may omit the calculation of H and Hᵢₙ at blocks 1006 and 1008. However, the input light field may still be recalculated based on a change in location of the target light field.

It is appreciated that the input light-field need not coincide with the physical input surface of the image-replicating combiner. For example, targeting the input light field near the input surface may also lead to a satisfactory target light field. In this context, “near” includes coincidence of the input light field with the input surface or a particular distance of the input light field from the input surface. In examples, the particular distance may be 5 mm, 10 mm, 20 mm, 30 mm and 40 mm. The particular distance may depend on a desired image quality of the target light field. For example, one consideration in a display system is to ensure that the physical area of the target light field roughly corresponds with the area of a human pupil. For this reason, the particular distance may be dependent on the area of the target light field. The closer the input light field is to the input surface, on the image generating unit side, the larger the area of the target light field due to the spreading of rays as they traverse the combiner. The closer the input light field is to the input surface, on the opposite side from the image generating unit, the smaller the area of the target light field will be.

Reverse propagation of the target light field through the combiner 1100 in order to calculate a corresponding input light field is one example of how such an input light field can be calculated. The present disclosure is not restricted to any particular method in order to perform such calculation. Although the method 1000 describes calculating an input light field by reverse-propagating the target light field through the combiner to the entrance pupil of the combiner, the input light field can also be calculated by forward propagating a light field from the entrance pupil to the location of the target light field. For example, forward propagation may be used in conjunction with an inverse-problem solver to determine a target light field from a given input light field. The input light field may undergo some form of iterative processing to generate a desired target light field. This is because for a given number of internal reflections, the propagation is strictly reversible so the direction of propagation is arbitrary.

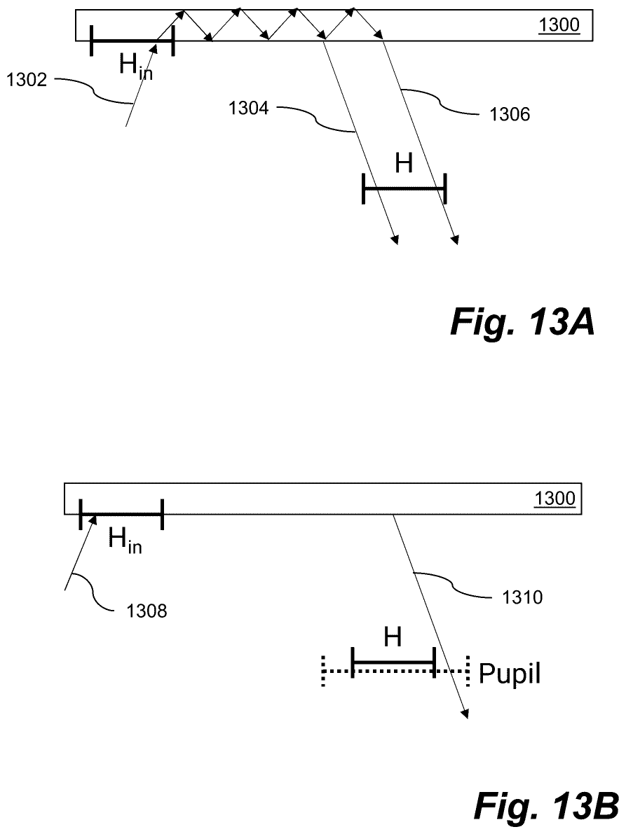

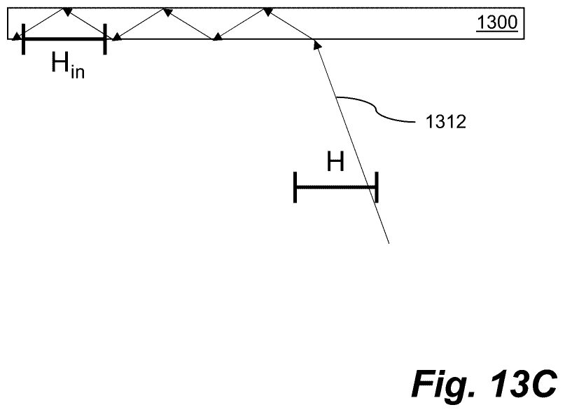

Regardless of how the input light field is determined, in order to improve the resultant image quality of the target light field, one or more of three conditions may be applied. These conditions will now be discussed with respect to FIGS. 13A, 13B and 13C.

The first condition requires that for every ray forward-propagated from Hᵢₙ, there may be no more than one ray which contributes to H. As a consequence of the properties of the combiner, a plurality of replications are extracted at the out-coupler of the combiner. It is possible for two or more copies of a ray incident on the entrance pupil of the combiner to form part of H. The results of the additional unintended rays forming H appear as image noise or artefacts. An example of a ray not satisfying this condition is shown in FIG. 13A. It can be seen that in this arrangement, a single incident ray 1302 on a combiner 1300 results in two rays 1304, 1306 being extracted from the combiner 1300 and forming part of H.

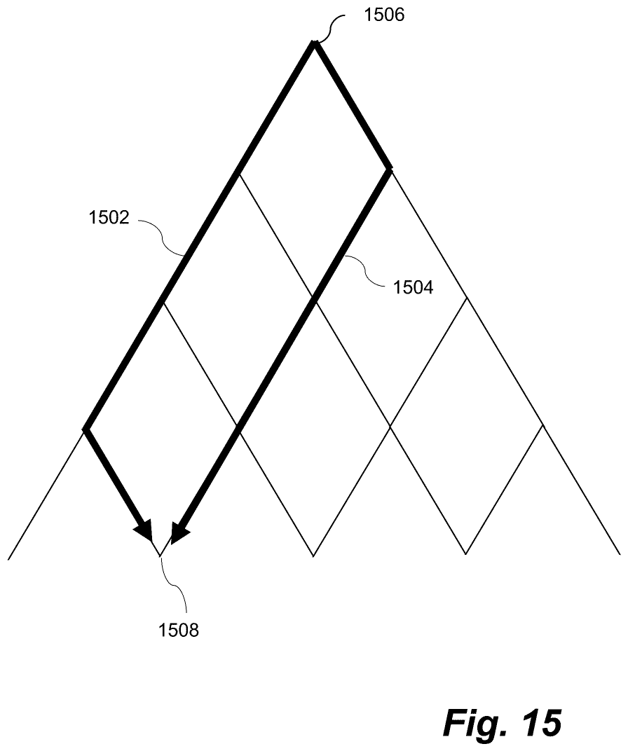

In some examples, the first condition does not apply to copies of rays which are substantially equivalent. A substantially equivalent ray includes one that has substantially the same path length but follows a different route through the combiner. This is not the situation depicted in FIG. 13A where each ray 1304, 1306 has a different path length. This will be discussed further with respect to FIG. 15 below.

A second condition requires that H is defined over a sufficiently large area to fully cover a viewer's pupil. If H is smaller in area than the viewer's pupil, then replicated rays not forming H may be received by the viewer's pupil resulting in undefined rays being seen by the viewer, appearing as image noise or artefacts. To overcome this, H may be defined to span an area at least that of the viewer's pupil, for example at least 4 mm or at least 6 mm across (corresponding to a typical size of a light-adapted pupil) or at least 8 mm or at least 10 mm across (corresponding to a typical size of a dark-adapted, or scotopic, pupil). Alternatively, if the light field defined by H is smaller than the area of the viewer's pupil, H may be defined to be zero for some border area of this region to reduce the required etendue. An example of a ray 1308 not satisfying the second condition is shown in FIG. 13B. In this example, H is defined to occupy an area smaller than the area of the viewer's pupil. The result is that an incident ray 1308 has a copy 1310 that does not form part of H, but intersects the viewer's pupil.

A third condition requires that for every ray back-propagated from H, there is a ray which contributes to Hᵢₙ. If this is not the case then there will be rays missing from H, as there is no way to produce them with a ray starting from Hᵢₙ. An example of a back-propagated ray 1312 not satisfying the third condition is shown in FIG. 13C. In this example, the back-propagated ray 1312, incident on the out-coupler of the combiner 1300 results in reflected rays that do not form part of Hᵢₙ.

For any process performing the method 1000 shown in FIG. 10A, the three conditions above should be roughly satisfied in order to achieve satisfactory results. While it is not critical for all the conditions to be met for every ray, rays not meeting these conditions will appear as errors in the image, so the total fraction of non-compliant rays (rays that do not meet all three conditions) should be small, such as less than 10%, less than 5%, less than 1%, less than 0.5%, or less than 0.1%. In some cases, where including a certain ray would result in one (or more) of the conditions being violated, that ray may be chosen to be omitted from H. Where this is the case, other rays in H may optionally be chosen to have increased intensity to compensate for the omission of the non-compliant ray.

By calculating an input light field according to the method 1000, or an alternative method, and roughly satisfying the three conditions described above, not only can the target light field be located within an arbitrary volume relative to the image-replicating combiner, but the resulting target light field will be displayed with reduced spurious noise and artefacts. In particular, problems typically associated with displaying near field images using image-replicating combiners, such as focus spread, are avoided by calculating an input light field specifically to generate a desired light field to be displayed to a viewer and ensuring unintended rays do not form part of the desired light field. This is in contrast to the usual method of generating a target light field in which the input light field is calculated first and displayed at an entrance pupil of a combiner in order to generate a plurality of replications.

Returning now to FIG. 2B, and with the above understanding, it can be seen how a light field may be chosen at the input such that the target light field is achieved within a given region of phase space at the output. For this to be achieved with maximum success, it is necessarily that the phase volumes of each discrete replication overlap as little as possible (this indirectly corresponds to the requirement illustrated in FIG. 13A that for a given ray at the input, no more than one ray should be present at the output). Additionally, the combined phase volumes of the discrete replications should cover as large a fraction of the specified output phase volume 208 as possible (this corresponds to the requirement illustrated in FIG. 13C that for every ray at the output there should be a corresponding ray at the input).

As discussed, these conditions do not need to be met exactly, and small deviations from these conditions may be compensated for by omitting certain rays and replacing them with compliant rays originating from the same object point.

The geometry of how discrete replications appear in phase space is a property of the image replicating combiner. In order to be generally compliant with the conditions described above it is clear that the image replicating combiner should be designed to provide optimal tiling of the replicated outputs in phase space. Specifically, it should be designed such that 1) A high fraction of the volume in phase space required for a target output phase volume is spanned by the combined phase volumes of the discrete replications; and 2) A low fraction of the volume in phase space required for a target output phase volume is covered by more than one overlapping discrete replication. In some examples, the combiner should be designed such that the combined phase volumes of the discrete replications span as much as 75%, 80%, 90%, 95%, and 99% of the volume in phase space required for a target output phase volume. However, a sufficiently high fraction depends on the characteristics of the light field and the pupil size of the user. In certain cases, an acceptable fraction could be as low as 5% (e.g. for a sparsely-sampled light field and highly dilated pupil). The volume in phase space covered by more than one overlapping discrete replication may be between 50% and 10% of the target output phase volume in some example, such as 50%, 40%, 30%, 20% or 10%. The volume in phase space covered by more than one overlapping discrete replication may be lower in other examples, such as 5% or 1% of the target output phase volume.

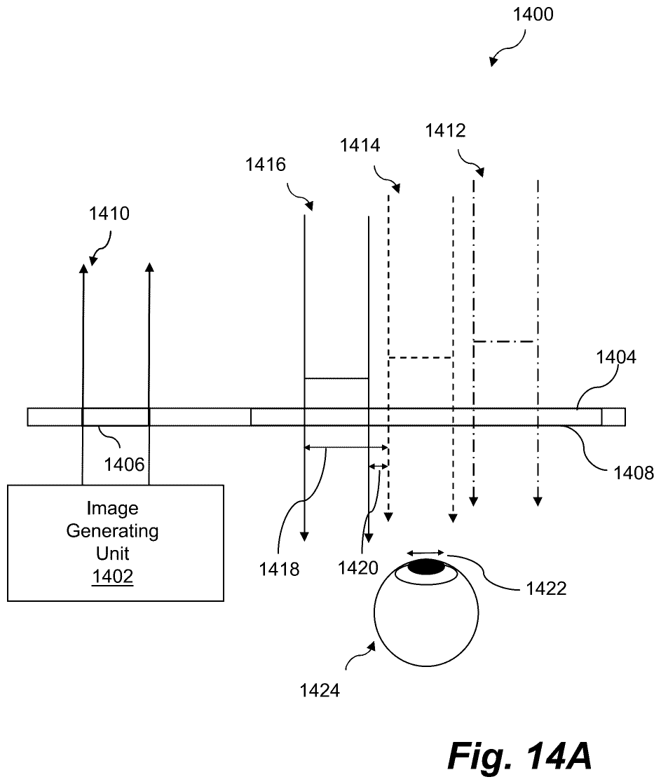

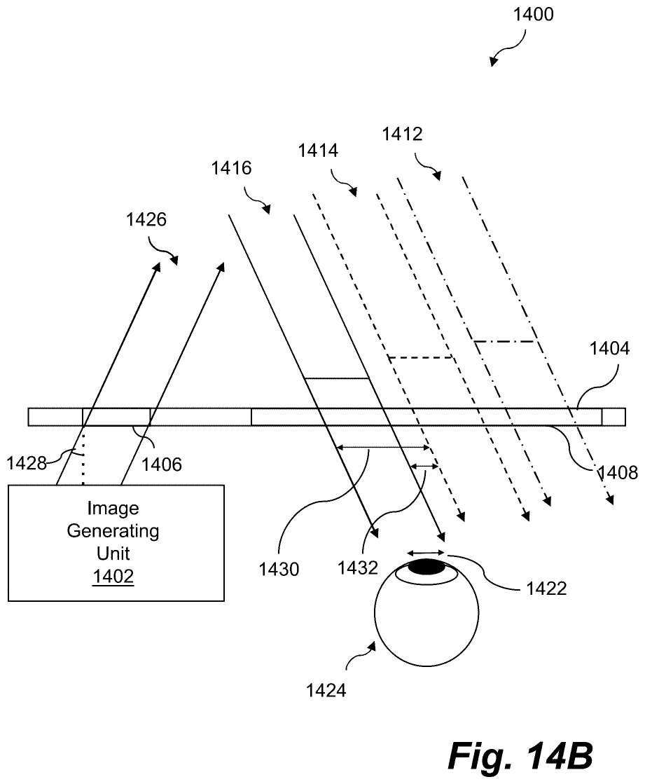

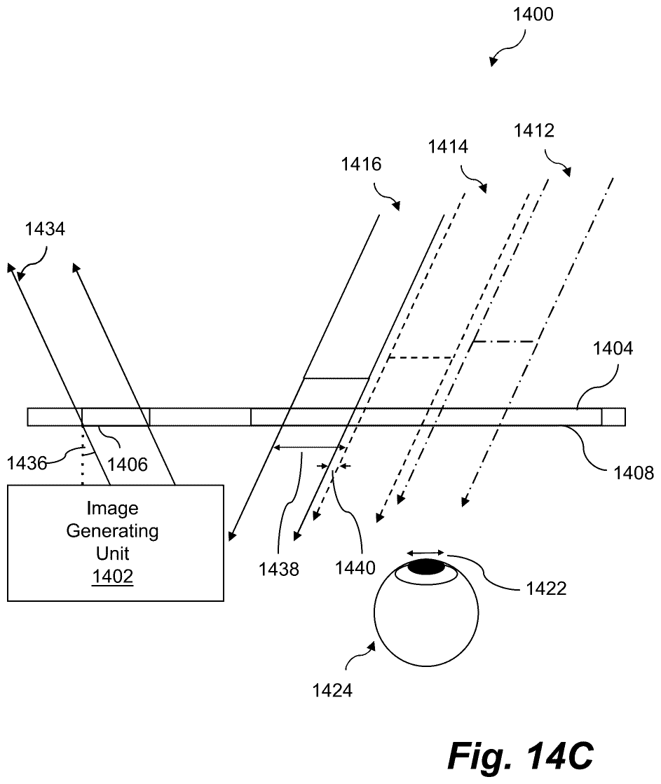

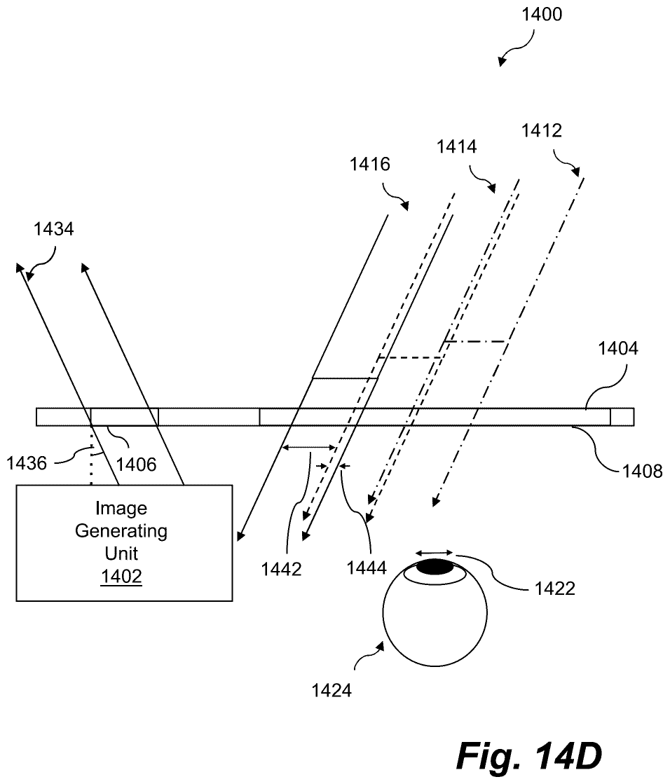

FIGS. 14A, 14B, 14C and 14D will now be used to discuss the way in which the geometry of an image replicating combiner is considered in terms of compliance with the above conditions. Although FIGS. 14A, 14B, 14C and 14D show replication along one axis, it may be easily seen how this concept may be extended to replication in 2 directions.

The ideal situation is described above, where the majority of the target phase volume is spanned with minimal overlap, and little or no correction for missing or duplicated rays needs to be applied. However, it may not be possible or efficient to produce an image generating unit with a sufficiently large phase volume, nor to produce an image-replicating combiner that does not have gaps between replications, so the preferred design may need to consider these practical limitations.

Referring to FIG. 14A, an input light field 1410, consisting only of rays travelling in the direction of normal incidence, is shown. This input light field is replicated multiple times, shown as 1412, 1414, 1416. Multiple replications of a single ray will be extracted from an image replicating combiner 1404 at an output surface 1408 at a certain spacing, 1418, which we refer to as the replication pitch. Where the width of the limiting aperture 1406 is smaller than the replication pitch 1418, there will be a gap between replications, 1420, where no rays are present for this angle of incidence. Note that the limiting aperture of the system 1400 may be the exit pupil of the image generating unit 1402, or the input pupil 1406 of the image replicating combiner 1404, whichever is smaller (although typically the design will be such that both are of approximately the same size).

The replication pitch 1418, and hence also the gap between replications 1420, is a function of the angle at which light enters the image replicating combiner 1404. Referring to FIG. 14B, for an input light field 1426, consisting only of rays at an incident angle indicated by 1428, the replication pitch 1430 will be maximised, resulting in a maximum gap between replications shown as 1432.

The location of the viewer's eye 1424 is also indicated, as well as the size of the viewer's pupil, shown at 1422. Provided the width of the viewer's pupil is greater than the maximum gap between replications then at least one ray from all angles will enter the eye, and any rays that cannot be represented due to the gap between replications may be compensated for by increasing the intensity of other rays.

Referring to FIG. 14C, for a different input light field 1434 consisting only of rays at an incident angle indicated by 1436, the replication pitch 1438 will be minimised, resulting in a minimum gap between replications shown as 1440. In certain embodiments, such as that illustrated in FIG. 14D, the minimum replication pitch 1442 may be smaller than the limiting aperture 1406. This results in the minimum gap between replications, 1444, becoming negative, meaning that there is overlap between neighbouring replications, rather than a gap.

In either case, provided the minimum replication pitch is greater than the width of the viewer's pupil, the viewer will see no more than one replication of any given ray. If the size of the viewer's pupil is greater than the minimum replication pitch, then rays for which more than one replication enters the pupil may be omitted, and compensated for with the increased intensity of other rays. This allows for the maximum pupil size to be approximately double the minimum replication pitch.

As the width of the viewer's pupil will depend on lighting conditions, and will additionally vary from person to person, a range of possible pupil sizes must be considered. The specific design of image generating unit and image replicating combiner will depend on the specified range of viewer's pupil sizes the system is specified to work with.

A typical application may be designed for a nominal viewer's pupil widths in the range 2-8 mm. To meet these conditions would require a maximum gap between replications to be less than the minimum viewer's pupil size of 2 mm, and the minimum replication pitch to be greater than 4 mm (i.e. greater than half the maximum viewer's pupil size). The output of such an image replicating combiner may only span a relatively small fraction of the target phase volume whilst still providing acceptable performance over a range of pupil sizes.

A specific non-limiting example of a waveguide may have the following parameters (with reference to elements of FIGS. 14A to 14D). The limiting aperture 1406 is 5.5 mm and a field of view is 18 degrees.

The waveguide has a glass substrate with thickness of 4.0 mm and a refractive index of 2.0. The input coupling grating has replication pitch 1418 that matches the limiting aperture width 1406 of 5.5 mm when the angle of incidence 1428,1436 is zero.

At incident angle 1428 (FIG. 14B) of +9° we have a replication pitch of 6.7 mm and therefore a maximum gap between replications 1432 of 1.2 mm. This is less than the typical minimum diameter of the human eye pupil.

At incident angle 1436 (FIG. 14D) of −9° we have a minimum replication pitch 1442 of 4.5 mm. This distance is larger than the diameter of a typical human eye pupil when ambient luminance is 1 Cd/m².

These parameters consider 1-dimensional replication along the same axis as the field-of-view measurement. But they do not change greatly in the case of the 2-dimensional replicating combiner, which a person skilled in the art can derive for themselves.

For other designs of 2D image replicating combiner the design might be such that the replicated phase volumes tessellate on a non-rectilinear grid.

In the case of an image replicating combiner design where the same pairing of input and output ray may be achieved via multiple distinct paths through the combiner (e.g. as in a WaveOptics® waveguide), the condition of non-overlapping phase volumes may be ignored for overlapping phase volumes that are nearly identical to one another. An example of how this type of combiner design operates is shown in FIG. 15. In particular, FIG. 15 shows a representation of different paths through such a combiner, and how rays may travel along distinct paths but arrive at the same point 1508 on an output surface of the combiner. For example, rays travelling along the two distinct paths through the combiner labelled 1502 and 1504 reach the same point on, or in, the combiner. Rays extracted at that point 1508 will have travelled along both of the paths 1502 and 1504 (as well as other possible paths through the combiner).

In some cases, such as with the image replicating combiner of FIG. 15, the rays received from at least two different replications of the input light field are coincident at a single point of the target light field, H. This is acceptable because those rays will generally have followed the same path length through the combiner so that they are substantially equivalent. In some examples, rays received at the single point of H at a first angle may be from a first replication and rays received at the single point of H at a second angle may be from a second replication.

Rays that follow different paths but are substantially equivalent are not limited to the construction of combiner depicted in FIG. 15.

### Binocular Imaging

The previous discussion has involved the calculation of an input light field in order to generate a desired light field, H, for near-eye display, and where H corresponds to a single contiguous pupil. In practice a binocular image can be formed by providing two displays, one for each pupil. Such a solution could be well suited to a conventional glasses format of head-mounted display, for example.

It is also possible for the above-described principles to be extended to calculate an input light field that, when displayed at an entrance pupil of an image-replicating combiner, forms multiple target light fields at arbitrary locations with respect to the combiner. In particular, the above described process for back-propagating pupils is still applicable, with H now being the sum of multiple back propagated light fields. This can be of particular use in head-mounted and head-up displays wherein only one image generating unit and one image-replicating combiner are required to generate two target light fields corresponding to both of a viewer's pupils, and displayed at locations corresponding to the positions of a viewer's pupils. Such a head mounted display might comprise a single visor covering both eyes, for example, while a head-up display might comprise a single screen, such as a windscreen, which is viewed by both eyes.

FIG. 16 is a schematic diagram of an example image-replicating combiner 1600 in which a light field at the entrance pupil 1602 of the combiner 1600 has been transformed to two target light fields, H₁ and H₂, at respective valid eyeboxes 1604, 1606 of the combiner 1600. A first valid eyebox 1604 is located at a distance |s₁| from the centre of the entrance pupil 1602 of the combiner 1600. A second valid eyebox 1606 is located at a distance |s₂| from the centre of the entrance pupil 1602 of the combiner 1600, wherein si and s₂ are displacement vectors from the centre of the valid eyeboxes 1604, 1606 to the centre of the entrance pupil 1602. Selecting s₁ and sz to align with a viewer's pupils allows this arrangement to form part of a binocular display wherein a single input light field, Hᵢₙ, may be calculated and displayed at the entrance pupil 1602 of the combiner 1600 in order to produce desired light fields H₁ and H₂ positioned within predetermined volumes with respect to the combiner 1600.

Provided the combined etendue of the multiple target light fields (H₁, H₂, . . . ) is less than the available etendue at H, then a solution may still exist. However, the more complicated geometry means that a combiner satisfying the three conditions described above with reference to FIGS. 13A, 13B and 13C for all pupils simultaneously is more complicated.

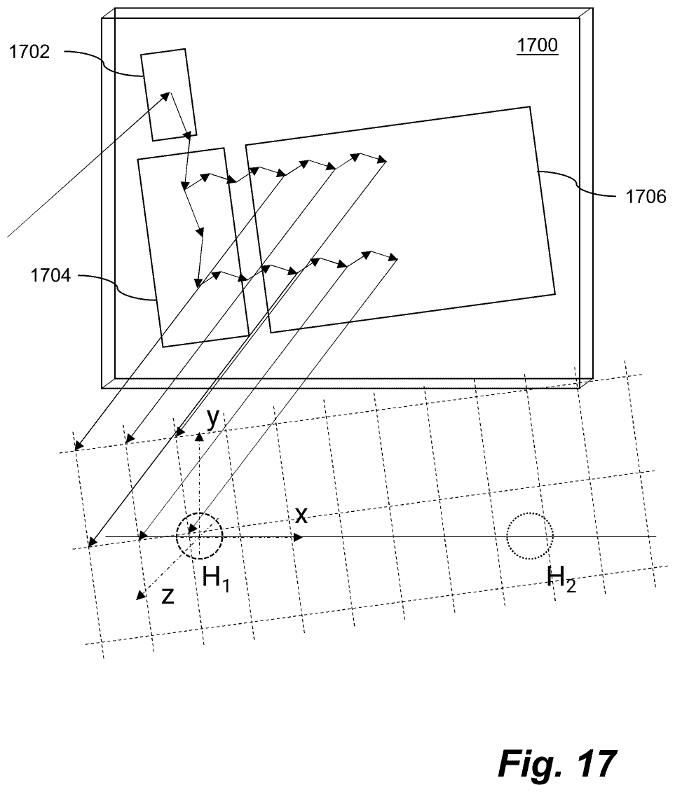

FIG. 17 shows an example image-replicating combiner 1700 comprising a grating geometry that may be used to produce target light fields H₁ and H₂ from a single input light field. The combiner 1700 comprises an in-coupling grating 1702, a redirection grating 1704 and an out-coupling grating 1706, that have similar coupling features to the corresponding gratings 1102, 1104, 1106 of the combiner 1100. However, the area of the entrance pupil of the combiner 1700 is double the area of the target pupil (the area of each of H₁ and H₂), with the same field of view, to achieve the required etendue. In this case, this is achieved with a 2:1 portrait aspect ratio, assuming a viewer's eyes are horizontal with respect to the combiner 1700. In FIG. 17, for example, both the line joining H₁ and H₂ and the combiner 1700 are aligned along the x-direction.

The method 1000 may be applied to this arrangement to calculate an input light field to display at the entrance pupil of the combiner in order to produce the target light fields H₁ and H₂. That is, a required location of each of the target light fields, H₁ and H₂, may be determined relative to the combiner. The required location may be the determined location of a viewer's pupils so that H₁ and H₂ are arranged to align with the pupils.

The target light fields, H₁ and H₂, to be displayed at the required locations are calculated. As described above, calculating H₁ and H₂ may occur before determining their required location. An input light field is then calculated by reverse-propagating the target light fields H₁ and H₂ through the combiner to the entrance pupil of the combiner. This can be achieved as discussed above with reference to FIG. 11, taking account of the more complicated geometry of the combiner (such as the combiner 1700). The calculated input light field may then be displayed at the entrance pupil of the combiner using an appropriate display method.

In order to improve the viewing experience for binocular viewing, the three conditions described above with reference to FIGS. 13A, 13B and 13C should be at least approximately satisfied. This can be achieved through the design of the combiner. For example, the gratings of the combiner may be rotated about a line perpendicular to the surface of the combiner and positioned at the centre of the combiner. In the example of FIG. 17, the gratings 1702, 1704, 1706 of the combiner 1700 are rotated with respect to the gratings 1102, 1104, 1106, relative to the combiner. The result is that the replications form a grid that is rotated with respect to the combiner 1700 when compared with the replications produced by the combiner 1100. In particular, the direction of the gratings is rotated by an angle, set during the design of the combiner 1700, to be arctan (pupil diameter IPD), for a given IPD. Typical values of IPD in the majority of human adults lie in the range 50-75 mm and studies have found that mean adult IPD is around 63 mm. When the line joining the viewer's eyes is horizontal with respect to the combiner 1700, this maximises the number of rays satisfying the required three conditions described above. That is, considering all the replications of rays that pass through H₁, a minimal number of unintended rays also pass through H₂, and vice versa.

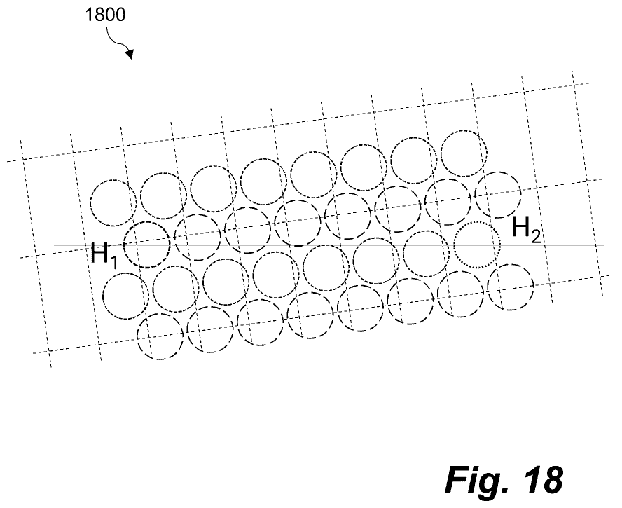

This example is further illustrated by now referring to FIG. 18 which shows the array of replications 1800 produced by the combiner 1700. A bundle of rays from a given field passing through H₁ will be replicated on a set pitch (shown by long dash outline) and similar for H₂ (shown with short dash outline). The angle and aspect-ratio of the replication pitch results in replicated rays from H₁ generally not intersecting with H₂, and vice versa. The replication pitch is generally a function of ray angle, so in general it will not be possible to meet the required conditions for all rays. However, as discussed above, rays not satisfying the three conditions may be omitted, and replaced with other rays originating from the same image point but satisfying the conditions, if possible.

The above arrangement may be implemented in any system that requires the display of target light fields for viewing by both of a viewer's pupils. Examples include a head-mounted display, a head-up display, a display panel or other display type. In the case of an automotive HUD, combiners according to the present disclosure may form part of a curved windshield that reflects light from the combiner to the viewer. The effect of this windshield may be modelled and taken into account during block 1004 of the method 1000 (propagation of the target light fields through the combiner).

### Example Display System

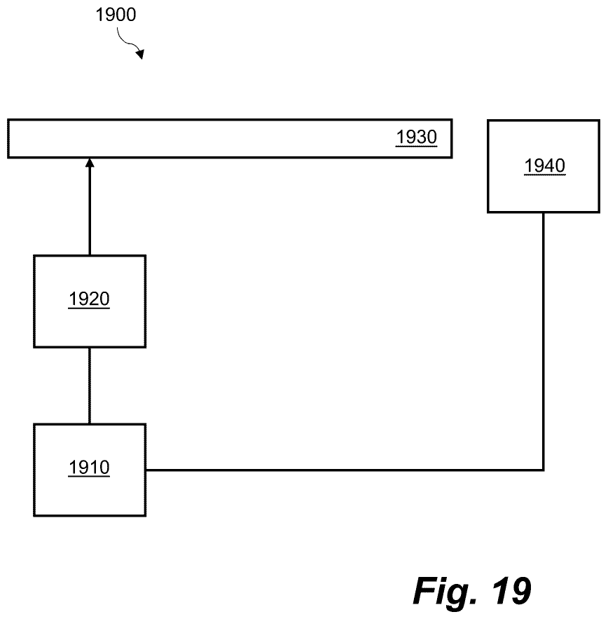

FIG. 19 shows a schematic diagram of an example display system 1900 that may be implemented in any of the above described systems to generate and display images to a viewer. The display system 1900 comprises a processing system 1910, an image generating unit 1920, an image-replicating combiner 1930, and an eye-tracking system 1940. The processing system 1910 may comprise one or more processors, memory, and software components. The one or more processors are configured to process data, and the memory can comprise a computer-readable medium (e.g., a tangible, non-transitory computer-readable medium, data storage loaded with one or more of the software components) configured to store instructions for performing various operations and/or functions. The processors are configured to execute the instructions stored on the memory to perform one or more of the operations.

The processing system 1910 is coupled to the image generating unit 1920 which is configured to generate light fields according to instructions received from the processing system 1910. The image generating unit 1920 is arranged to display an input light field near an entrance pupil of the image-replicating combiner 1930, such that the image-replicating combiner 1930 produces a target light field for display to a viewer.

The eye-tracking system 1940 is coupled to the processing system 1910 and is configured to monitor a location of a viewer's pupil. The eye-tracking system 1940 provides the processing system 1910 data indicating the location of the viewer's pupil. The eye-tracking system 1940 may provide periodically, aperiodically or continuously updated data indicating the location of the viewer's pupil as a function of time. The processing system 1910 uses the provided data to determine a location at which to display the target light field (e.g. block 1002 of the method 1000). The processing system 1910 also calculates the target light field to be displayed at the determined location (e.g. block 1006 of the method 1000). Further, the processing system 1910 is configured to calculate the input light field by first determining a transfer function that defines the propagation of light through the image-replicating combiner, between the target light field at the viewing location and an input location near to an input surface of the image-replicating combiner; applying the transfer function to the target light field to obtain the input light field; and displaying the input light field at the input location. The processing system 1910 is further configured to instruct the image generating unit 1920 to display the calculated input light field (e.g. block 1010 of the method 1000).

In some examples, the eye-tracking system 1940 is configured to generate data indicating the location of the viewer's pupil as part of an initial calibration procedure. After that initial calibration procedure the eye-tracking system 1940 may then not further monitor the location of a viewer's pupil, so that the location remains the same until another calibration is executed.

### Tilted Image Generating Unit

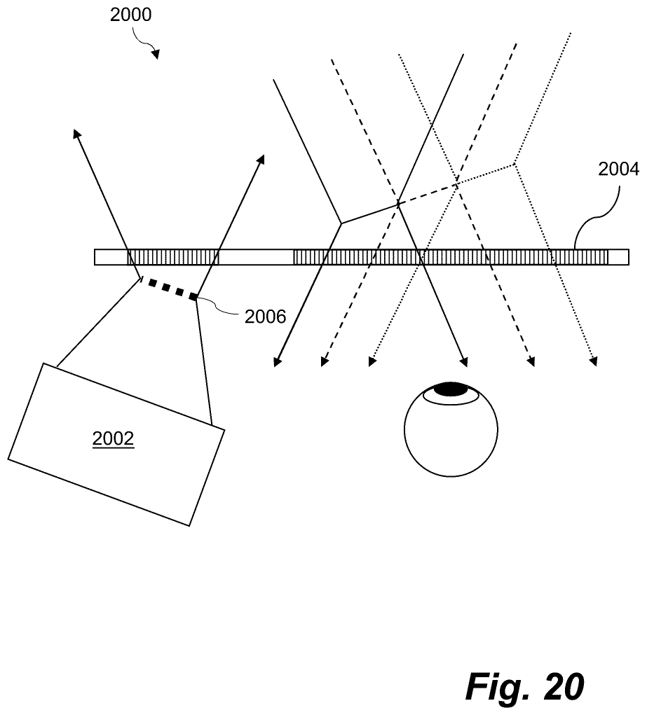

In FIG. 11, the image generating unit (not shown) is arranged to provide the input light field such that the exit pupil of the image generating unit roughly coincides with and is generally parallel to the input coupler 1102 of the combiner 1100 (similar to the arrangement shown in FIG. 7a-7d). However, this need not be the case. FIG. 20 shows an example optical system 2000 having an image generating unit 2002, image-replicating combiner 2004 and a grating 2006 at the exit pupil of the image generating unit 2002, such that the exit pupil of the image generating unit 2002 is tilted with respect to the input surface of the image-replicating combiner. The replicated images of the exit pupil, as seen from the combiner output-eyebox, lie in a single plane. As such, gaps between the exit pupil images can be minimised. This may improve the uniformity of the image as viewed by the eye. Additionally, the optical path length between neighbouring exit pupil images may be minimised so that coherence may be maintained across the exit pupil images, even when illumination sources in the image generating unit have low coherence length. This may improve the resolution of the image as viewed by the eye.

In this example, the grating 2006 at the image generating unit 2002 exit-pupil allows the field of view to be centred on the axis perpendicular to the image replicating combiner 2004 output surface. Another means of tilting the bundle of rays emitted by the image generating unit 2002, is a prism. Such a grating or prism could be an integral part of an image replicating combiner 2004.

### Experimental Results

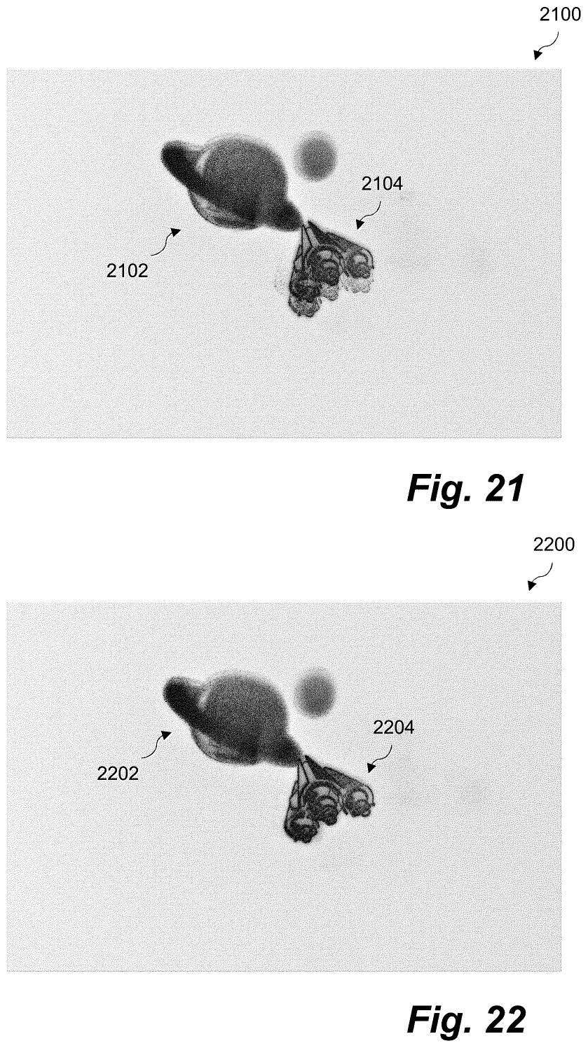

FIG. 21 shows an image 2100 generated by a conventional display system, such as the display system 300 shown in FIG. 3. In this example, the image generating unit has an exit pupil diameter of 14 mm and a field of view of around 10 degrees (diagonally). The image 2100 was captured using a camera with an input pupil size of 5 mm. The image 2100 is similar to the example discussed with respect to FIGS. 5 and 6, but wherein the astronaut 504, 604 is replaced with a spaceship 2104. Again, the planet 2102 is an object at infinite depth such that rays emanating from any point on the planet 2102 are collimated. Therefore, as expected, the planet 2102 is displayed without artefacts. On the other hand, the spaceship 2104 is an object with finite depth such that rays emanating from any point on the spaceship 2104 object are uncollimated. The effect of ghosting resulting from the finite depth of the spaceship 2104 can be clearly seen, and the result is an unsatisfactory holographic viewing experience.

FIG. 22 shows an image 2200 generated by a display system according to the examples described herein where a transfer function is determined and applied to the target light field before display (such as any of the display systems 700, 800, 900, 1600, 1900). The image generating unit used was the same as used in the conventional display system used to generate the image 2100 shown in FIG. 21. The same camera used to capture the image 2100 shown in FIG. 21 was also used to capture the image 2200 shown in FIG. 2200. It can be observed that the effect of applying either of the methods 1000, 1020 results in a holographic image with much reduced ghosting of objects at finite depth. As in FIG. 21, the planet 2202 is displayed without ghosting because it is displayed at infinite depth using collimated rays. However, now also the spaceship 2204 is shown as a single object without any significant ghosting. Thus, it can be seen that the techniques described herein can be used to generate holographic images providing an improved viewer experience compared to holographic images generated using conventional display systems.

Note that parts of the present disclosure have referred to the concept of rays. In the case where His describing a hologram, the concept of a ‘omitting a ray’ may be taken as meaning ‘removing spatial frequencies from some localised region of H’.

The above embodiments are to be understood as illustrative examples of the invention. For example, an image-replicating combiner includes any type of image-replicating combiner, examples of which include waveguide combiners and freeforms, it is not limited to the specific examples of 2D image replicating waveguides with planar input and output surfaces used in some embodiments.

Although the detailed description has focused on reverse-propagation from a target light field back to an input light field, the methods can equally be applied to forward propagation from an input light field to a target light field.

Further embodiments of the invention are envisaged, for example using alternative design methods, such as methods using similar design constraints and assumptions. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of displaying a target light field using an image-replicating combiner, the method comprising:
determining a target light field to be displayed at a viewing location;
determining a transfer function describing the propagation of light through the image-replicating combiner between the viewing location and an input location near to an input surface of the image-replicating combiner;
determining an input light field by applying the determined transfer function to the target light field; and
displaying the input light field at the input location.

2. The method of claim 1, comprising:
determining that more than one copy of a ray incident on the input surface of the image-replicating combiner is present in the target light field; and one of:
omitting the ray from the input light field; and
determining that at least two copies of the ray are substantially equivalent and retaining the at least two copies of the rays in the input light field.

3. The method of claim 1, comprising:
determining that a ray back-propagated from the target light field to the entrance pupil of the image-replicating combiner is not present in the input light field; and
omitting the ray from the target light field.

4. The method of claim 3, comprising increasing the power of another ray to compensate for the omitted ray.

5. The method of claim 1, wherein the target light field is at least as large as a pupil of a viewer at the viewing location.

6. The method of claim 1, wherein an area of the target light field is less than an area of a pupil of a viewer, the method comprising:
expanding the target light field with elements of zero-amplitude such that the expanded target light field has an area at least the size of the pupil.

7. The method of claim 1, wherein determining the target light field comprises:
decomposing the target light field into a set of plane waves using a discrete Fourier transform; and
applying a padding to the boundary of the target light field comprising elements of zero-amplitude.

8. The method of claim 1, comprising:
determining a position of a viewer's pupil, and
wherein the viewing location is the determined position of the viewer's pupil.

9. The method of claim 1, wherein the target light field comprises a plurality of separate light fields each having a respective viewing location, the method comprising:
determining a target light field and determining an input light field for each of the plurality of separate light fields; and
combining the input light fields for each of the plurality of separate light fields for display.

10. The method of claim 1, wherein the target light field and the input light field are holographic fields or 4-dimensional light fields.

11. The method of claim 1, wherein:
the target light field is a holographic light field;
the viewing location is substantially constant; and
the determining an input light field uses a predetermined constant based on the propagation between the viewing location and the input location.

12. The method of claim 1, wherein the input location is a surface that is not parallel to the input surface of the image-replicating combiner.

13. The method of claim 1, wherein determining the transfer function comprises determining that rays received from at least two different replications of the input light field are to form the target light field.

14. The method of claim 13, wherein the rays received from at least two different replications are coincident at a single point on a virtual object.

15. A display system comprising:
an image-replicating combiner;
an image generating unit arranged to provide an input to the image-replicating combiner; and
a processing system configured to cause the image generating unit to display an input light field by:
determining a target light field to be displayed at a viewing location;
determining a transfer function describing the propagation of light through the image-replicating combiner between the viewing location and an input location near to an input surface of the image-replicating combiner;
determining an input light field by applying the determined transfer function to the target light field; and
displaying the input light field at the input location.

16. The display system of claim 15 comprising:
an eye-tracking system arranged to provide data indicative of the viewing position to the processing system.

17. The display system of claim 15, wherein the image-replicating combiner is at least one of:
configured such that all replications have substantially the same output power for the same input power;
not parallel to the input surface of the image-replicating combiner;
arranged to generate a plurality of replicated images of the input light field, and a gap between neighbouring replicated images is no larger than a diameter of a viewer's pupil; or
arranged to generate a plurality of replicated images of the input light field, and a combined phase volume of the plurality of replicated images covers the majority of a target phase volume.

18. The display system of claim 15, wherein, the image-replicating combiner is arranged to generate a plurality of replicated images of the input light field, and a combined phase volume of the plurality of replicated images covers the majority of a target phase volume, the phase volumes of the replicated images overlap in a small fraction of the target phase volume.

19. The display system of claim 15, wherein a replication pitch of the image replicating combiner is at least one of:
approximately equal to the width of the input pupil; or
greater than half the diameter of a viewer's pupil.

20. A head-mounted display or a head-up display comprising a display system comprising:
an image-replicating combiner;
an image generating unit arranged to provide an input to the image-replicating combiner; and
a processing system configured to cause the image generating unit to display an input light field by:
determining a target light field to be displayed at a viewing location;
determining a transfer function describing the propagation of light through the image-replicating combiner between the viewing location and an input location near to an input surface of the image-replicating combiner;
determining an input light field by applying the determined transfer function to the target light field; and
displaying the input light field at the input location.
